(19) United States
(12) Patent Application Publication
(10) Pub. No.: US 2012/0023206 A1
(43) Pub. Date: Jan. 26, 2012

(54) ADDRESS DISTRIBUTING METHOD AND DEVICE

(76) Inventors: Katsumi Kusama, Tokyo (JP); Atsushi Takahashi, Tokyo (JP); Taro Takahashi, Tokyo (JP); Shinsuke Watanabe, Tokyo (JP)

(21) Appl. No.: 13/083,252

(22) Filed: Apr. 8, 2011

(30) Foreign Application Priority Data
Apr. 12, 2010 (JP) 2010-091548

(51) Int. Cl. G06F 15/177

(52) U.S. Cl. 709/220

(57) ABSTRACT

A system is disclosed that includes a plurality of node devices arranged in sequence; a first node device operable to generate a device count frame with a device count number and transmit the device count frame to the next node device in the sequence; a control device in communication with at least the first node device; wherein each node device is operable to increase the device count number of the device count frame upon receipt of the device count frame and transmit the device count frame to the next node device in sequence; and wherein the control device operable to receive the device count frame to the first node device after each node device has increased the device count number of the device count frame and assign an IP address for each node device, the number of IP addresses determined by the device count number.

### CROSS-REFERENCE TO RELATED APPLICATIONS

This application is based upon and claims the benefit of priority from Japanese Patent Application No. 2010091548, filed on Apr. 12, 2010, the entire contents of which are incorporated herein by reference.

### TECHNICAL FIELD

The present disclosure relates to an address distributing method and device for a network provided mainly in the rail vehicles.

### BACKGROUND

Various equipment for the driving system such as motors and brakes, the monitor system to monitor the state of equipment, and the service data for traveler service and so on are loaded in rail vehicles, and it is expected to compose these by a network from a point of reducing the installation cost. From these requests, the number of equipment to be connected to the network becomes larger compared to before.

Conventionally, as the network was built up for each of the service systems such as the driving system and the monitor system, the number of the network equipment to be connected to each network is small, and in addition, as once the equipment itself is installed, it is not changed fundamentally, so that it is commonly-used that an IP (internet protocol) address to identify the destination of the data to control these is set in each equipment.

Usually a MAC address is previously set for the equipment to be connected to the network, and this address is determined uniquely for each equipment. This MAC address is an address applied to the LAN of Ethernet (registered trademark), is previously set at the time of shipping each equipment, for example, and is the data that cannot be changed later. In this case, as the MAC addresses are different individually for even the equipment of the same type, it becomes a troublesome work for the managing device that manages these equipment by the MAC addresses to change the address of the object to be controlled at the managing device side every time the equipment is exchanged. For this reason, different from the MAC address that is set for each equipment, the IP address is usually used.

By using the IP address, even if the equipment is exchanged due to failure and so on, the IP address of the target equipment seen from the managing device is not changed, so that there is a merit that the change of the address of the object to be controlled is not generated at the managing device side.

For this reason, it is necessary to set the IP address for the equipment to be connected to the network. In the case that the number of the target equipment to be set is small, it is possible to set manually, but when the number of the target equipment increases, to set the IP addresses manually requires a lot of labor and time. To solve this, there is a method for setting IP automatically by a DHCP server. According to this method, it is possible to distribute the IP address automatically to the equipment, but it is difficult to identify the content of the equipment and its installation place. For this reason, in the case that the equipment is used as an object to be controlled, as the actual condition of the object to be controlled is not known from the managing device side, there is a problem that the equipment cannot be controlled. In the case of operating the train, the action of the motors and brakes and opening and closing the doors and so on are controlled, but in the case that the managing device controls these equipment, if the IP address in which the equipment to be targeted and its place are correlated with is not known, it is not possible to designate even whether to open the right door or to open the left door, for example.

For this reason, a method of obtaining the information of the position of the terminal is known, but it is presupposed that where the node device (switching hub) of the network is present is known.

In addition, a scheme to distribute automatically the address information of a plurality of networks is known, but an arrangement diagram of the equipment to be targeted is required separately or it is necessary that the node device has the information.

As described above, it is possible to set the IP address automatically according to the conventional technology, but it was not possible to learn up to the attribute and installation position of each equipment. For this reason, there is a problem that in the automatic setting of the IP address, it is not possible to identify the IP address of the equipment to be controlled at the management device side.

In particular, in the network used in the train, there is a case that the formation of the train is changed according to its operation, and it is possible to change the network address manually each time of changing in the case that the number of the terminals to be targeted is small, but in the case when the number of the terminals is increased, a long time is required and the trouble in operation may be caused.

In addition, at the management device side, as each time the formation is changed the target equipment to be controlled is added/deleted, it is necessary to change the control structure by grasping the target equipment to be added/deleted. Conventionally, the same control was performed for each vehicle, with respect to motors and brakes, for example, but the development for the future has been made to perform effective control for the formation as a whole by controlling individually the motors and brakes for each vehicle. In order to control the equipment individually like this, the scheme is necessary that the management device side can automatically correlate the usable IP address with the equipment attribute and position information.

Accordingly, an object of the present disclosure is to provide an address distributing method and a device in which a management device side can control a terminal equipment by allotting an IP address of each node device or terminal automatically in the network in the rail vehicle, even if the formation is changed. In addition, an object of the present disclosure is to provide a monitoring method and a monitoring device for confirming the normality of the terminal equipment using the present system.

### SUMMARY

A method is disclosed that included arranging a plurality of node devices in sequence; generating a device count frame with a device count number in a first node device; transmitting the device count frame to each node device in sequence, each node device increasing the device count number of the device count frame upon receipt of the device count frame; returning the device count frame to the first node device after each node device has increased the device count number of the device count frame; and assigning an IP address for each node device, the number of IP addresses determined by the device count number. The method also includes associating a plurality of terminal devices to each node device; and transmitting terminal device hardware information from each terminal device to the respective associated node device. The hardware information includes a MAC address, an interface number, and hardware attribute information.

The method also includes each terminal device transmitting a data frame containing its MAC address and interface number to its respective node device; each node device generating an address table containing its respective terminal device MAC addresses and interface numbers; and a control device obtaining the address table from each of the node devices and requesting a terminal attribute for each terminal device using the MAC address of each terminal device. The method also includes each terminal device transmitting the terminal attribute in accordance with the terminal attribute request; the control device receiving each terminal attribute, generating an IP address for each terminal device, transmitting the IP address to each terminal device; and each terminal device setting its IP address to the received IP address transmitted to it. Transmitting the IP address to each terminal device includes transmitting a sequential list of IP addresses, and wherein each terminal device setting its IP address comprises setting the terminal device's IP address to the first IP address in the list, removing the first IP address on the list, and transmitting the list to another terminal device. The method also includes generating configuration information indicating a construction of the system using the terminal attribute and the MAC address tables in the control device. The node devices can be arranged in a loop. The node devices can be arranged on a bus.

A system is also disclosed that includes a plurality of node devices arranged in sequence; a first node device operable to generate a device count frame with a device count number and transmit the device count frame to the next node device in the sequence; a control device in communication with at least the first node device; wherein each node device is operable to increase the device count number of the device count frame upon receipt of the device count frame and transmit the device count frame to the next node device in sequence; and wherein the control device operable to receive the device count frame to the first node device after each node device has increased the device count number of the device count frame and assign an IP address for each node device, the number of IP addresses determined by the device count number.

The system also includes a plurality of terminal devices associated with each node device, each terminal device operable to transmit terminal device hardware information to the respective associated node device. The hardware information includes a MAC address, an interface number, and hardware attribute information. Each terminal device is further operable to transmit a data frame containing its MAC address and interface number to its respective node device, each node device is further operable to generate an address table containing its respective terminal device MAC addresses and interface numbers; and the control device is operable to obtain the address table from each of the node devices and request a terminal attribute for each terminal device using the MAC address of each terminal device. Each terminal device is further operable to transmit the terminal attribute in accordance with the terminal attribute request, the control device is further operable to receive each terminal attribute, generate an IP address for each terminal device, and transmit the IP address to each terminal device, each terminal device further operable to set its IP address to the IP address transmitted to it by the control device. The system also includes a plurality of rail vehicles, each node device associated with a single rail vehicle.

A system is disclosed that includes a control device in communication with a plurality of node devices, each node device associated with a rail vehicle, each rail vehicle arranged in sequence, wherein the control device is operable to: receive a device count frame with a device count number, the device count number equaling the number of node devices; and assign an IP address to each node device based on the number of node devices indicated in the device count frame. The control device is further operable to: receive address tables generated by each of the node devices, the address table generated by each node device and comprising a MAC address and interface number from a plurality of terminal devices, request a terminal attribute from each terminal device using the MAC address of each terminal device from the address table; receive each terminal attribute from each terminal device; generate an IP address for each terminal device; and transmit the IP address to each terminal device, each terminal device setting its IP address to the IP address transmitted to it by the control device. The control device is further operable to transmit the IP address to each terminal device by transmitting a sequential list of IP addresses, each terminal device setting its IP address to the first IP address in the list, removing the first IP address on the list, and transmitting the list to another terminal device. The control device is further operable to generate configuration information indicating a construction of the system using the terminal attribute and the address tables. The node devices can be arranged in a loop. The control device is further operable to transmit a status request to at least one terminal device, receive a status response from the terminal device in response to the status request, and report the status response of the terminal device.

### BRIEF DESCRIPTION OF THE DRAWINGS

FIG. 1 is a construction diagram of an embodiment in a ring type network to which the present disclosure is applied.

FIG. 2 is a flow chart showing an initial operation in the address distribution of the network control device 4.

FIG. 3A is a flow chart to obtain the number of the node devices.

FIG. 3B is a diagram showing a fundamental frame configuration of the data frame.

FIG. 3C is a diagram showing a configuration of the node device count frame 310.

FIG. 4 is a flow chart showing IP address generation for the node device in the network control device.

FIG. 5A is a flow chart when the network control device transmits the IP address to be distributed to the master node device and the master node device distributes the IP address to the node device.

FIG. 5B is a diagram showing a configuration of the IP address distribution frame 320.

FIG. 6A is a flow chart for sending out the association frame in the terminal equipment.

FIG. 6B is a diagram showing a configuration of the association frame 330.

FIG. 7 is a flow chart to register the MAC address of the terminal equipment to the MAC address table in the master node device and the node device.

FIG. 8A is a flow chart when the network control device obtains the MAC address table of the master node device and the node device till transmits the terminal attribute request frame to the terminal equipment.

FIG. 8B is a diagram showing a configuration of the correspondence table.

FIG. 8C is a diagram showing a configuration of the terminal attribute request frame 340.

FIG. 9A is a flow chart when the terminal equipment receives the terminal attribute request frame and sends back the terminal attribute.

FIG. 9B is a diagram showing a configuration of the terminal attribute response frame 350.

FIG. 10A is a flow chart after the network control device receives the terminal attribute request response frame.

FIG. 10B is a diagram showing the construction of the configuration information.

FIG. 10C is a diagram showing a configuration of the terminal equipment IP address distribution frame 360.

FIG. 11A is a flow chart after the terminal equipment receives the IP address distribution frame.

FIG. 11B is a diagram showing a configuration of the IP address distribution response frame 370.

FIG. 12A is a flow chart after the network control device receives the IP address distribution response frame.

FIG. 13A is a flow chart when the master node device sets the node number to the node device.

FIG. 13B is a diagram showing a configuration of the node number distribution frame 380.

FIG. 14A is a flow chart when the master node device distributes the IP address to the node device.

FIG. 14B is a diagram showing a configuration of the IP address distribution frame 390.

FIG. 14C is a diagram showing a configuration of the IP address setting notification frame 400.

FIG. 15 is a flow chart when the network control device distributes the primary IP address to the terminal equipment.

FIG. 16 is a flow chart to set the primary IP address in the terminal equipment.

FIG. 17 is a flow chart of the terminal attribute request after confirming the first IP address setting in the network control device.

FIG. 18 is a flow chart of an operation for the terminal attribute request in the terminal equipment.

FIG. 19 is a flow chart after the network control device allots the primary IP address and obtains the terminal attribute.

FIG. 20 is a flow chart in which the terminal equipment changes the setting from the primary IP address to the IP address extracted from the terminal control.

FIG. 21 is a flow chart after the network control device distributes the primary IP address to the terminal equipment, and sets to the IP address extracted from the terminal control again.

FIG. 22 is a flow chart after the network control device obtains the configuration information under the control of the node device from the master node device and the node device, till sends out the IP address distribution frame to the terminal equipment.

FIG. 23 is a flow chart after the network control device obtains the configuration information under the control of the node device and the type of structure from the master node device and the node device, till sends out the IP address distribution frame to the terminal equipment.

FIG. 24 is a flow chart when the network control device confirms the normality of the terminal equipment.

FIG. 25 is a flow chart when the terminal equipment sends out the response to the normality confirmation to the network control device.

FIG. 26 is a construction diagram when the present disclosure is applied to the bus type network.

FIG. 27 is a flow chart when the master node device obtains the number of the node devices and the terminal node device till notifies to the network control device.

FIG. 28 is a flow chart when the master node device distributes the node numbers to the node devices and the terminal node device till notifies to the network control device.

FIG. 29 is a construction diagram in the case that the node device 2, the master node device 5 and the terminal node device 34 each have the node number setting unit to set the node number.

FIG. 30 is a construction diagram in the case that the node device 2, the master node device 5 and the terminal node device 34 each has the configuration information under the control of the node device memory unit to store the configuration information under the control of the node device.

FIG. 31 is a construction diagram in the case that the node device 2, the master node device 5 and the terminal node device 34 each has the node number setting unit to set the node number and the configuration information under the control of the node device memory unit to store the configuration information under the control of the node device.

FIG. 32 is a construction diagram of an embodiment of the present disclosure in which the node device 2, the master node device 5 and the terminal node device 34 each has the configuration information under the control of the node device memory unit and the type of structure.

FIG. 33 is a construction diagram in the case that the node device 2, the master node device 5 and the terminal node device 34 each has the node number setting unit, the configuration information under the control of the node device memory unit to store the configuration information under the control of the node device, and the type of structure memory unit to store the type of structure.

FIG. 34 is a construction diagram where node device 2, the master node device 5 and the terminal node device 34 each has the node number setting unit to set the node number, the network control device 4 has the node device node number processing unit.

FIG. 35 is a construction diagram where node device 2, the master node device 5 and the terminal node device 34 each counts the number of the node devices, the network control device 4 has the primary IP address generating unit so as to distribute the primary IP address.

FIG. 36 is a construction diagram where node device 2, the master node device 5 and the terminal node device 34 each sets the node device node number, the network control device 4 has the primary IP address generating unit so as to distribute the primary IP address.

FIG. 37 is a construction diagram where node device 2, the master node device 5 and the terminal node device 34 each counts the number of the node devices, the network control device 4 has the configuration information under the control of the node device collecting unit so as to collect the configuration information under the control of the node device.

FIG. 38 is a construction diagram where node device 2, the master node device 5 and the terminal node device 34 each sets the node device node number, the network control device 4 has the configuration information under the control of the node device collecting unit so as to collect the configuration information under the control of the node device.

FIG. 39 is a construction diagram where node device 2, the master node device 5 and the terminal node device 34 each counts the number of the node devices, the network control device 4 has the configuration information under the control of the node device collecting unit and the type of structure collecting unit so as to collect the configuration information under the control of the node device and the type of structure, respectively, and the sub terminal control memory unit to store the sub terminal control so as to generate the terminal control.

FIG. 40 is a construction diagram where node device 2, the master node device 5 and the terminal node device 34 each sets the node device node number, the network control device 4 has the configuration information under the control of the node device collecting unit and the type of structure collecting unit so as to collect the configuration information under the control of the node device and the type of structure, respectively and the sub terminal control memory unit to store the sub terminal control so as to generate the terminal control.

FIG. 41 is a construction diagram in the case that the network control device 4 has the abnormality detection control unit so as to confirm the normality of the terminal.

FIG. 42 is a construction diagram in the case that the network control device 4 has the abnormality detection control unit so as to confirm the normality of the terminal, and shows a modification of FIG. 41.

FIG. 43 is a construction diagram in the case that the network control device 4 has the abnormality detection control unit so as to confirm the normality of the terminal, and shows a modification of FIG. 41.

FIG. 44 is a construction diagram in the case that the network control device 4 has the abnormality detection control unit so as to confirm the normality of the terminal, and shows a modification of FIG. 41.

FIG. 45 is a construction diagram in the case that the network control device 4 has the abnormality detection control unit so as to confirm the normality of the terminal, and shows a modification of FIG. 41.

FIG. 46 is a construction diagram in the case that the network control device 4 has the abnormality detection control unit so as to confirm the normality of the terminal, and shows a modification of FIG. 41.

### DETAILED DESCRIPTION OF THE EMBODIMENTS

Hereinafter, an IP address distribution method and a device according to embodiments of the present disclosure will be described specifically with reference to the drawings.

### First Embodiment

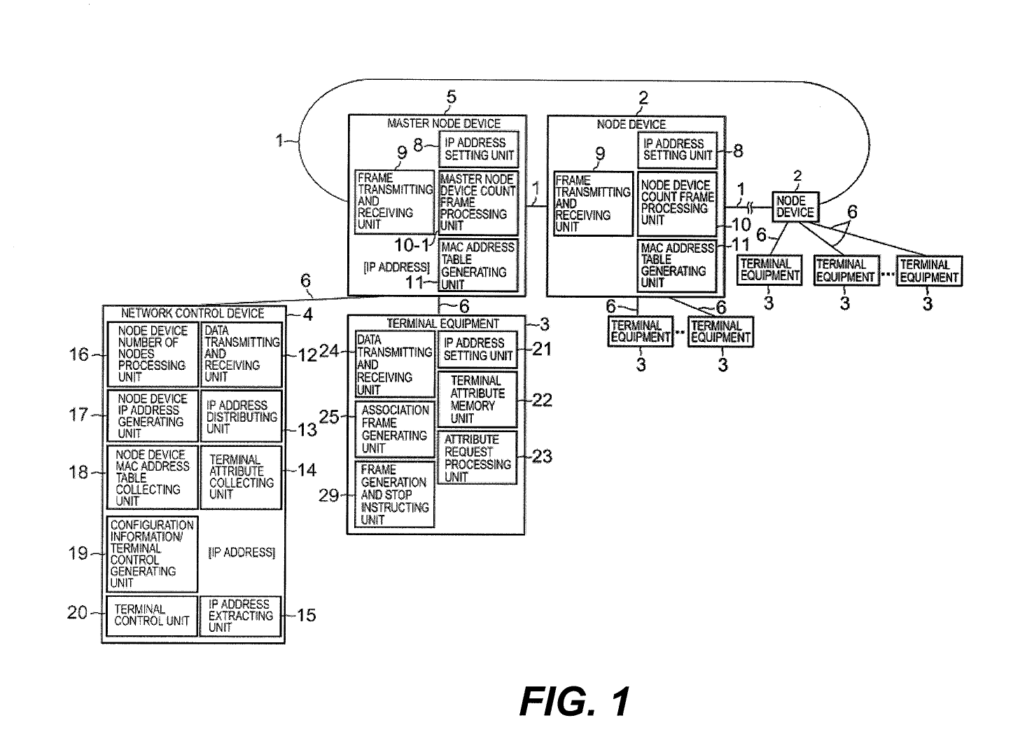

FIG. 1 is a diagram of a ring type network relating to the present disclosure and its construction, and a main transmission line of a ring type is composed of a main transmission line 1, a master node device 5, and a plurality of node devices 2, and the node device 2 is installed by one for each vehicle. Terminal equipment 3 are connected to the node device 2 via branch transmission lines 6, respectively, and a network control device 4 is connected to the master node device 5 via the branch transmission line 6.

The node device 2 and the master node device 5 each includes an IP address setting unit 8, a frame transmitting and receiving unit 9, a node device count frame processing unit 10 or a master node device count frame processing unit 10-1, and a MAC address table generating unit 11. In addition, with respect to the general function as the fundamental switching hub, the description will be omitted.

The network control device 4 is composed of a data transmission and receiving unit 12, an IP address distributing unit 13, a terminal attribute collecting unit 14, an IP address extracting unit 15, a node device number of nodes processing unit 16, a node device IP address generating unit 17, a node device MAC address table collecting unit 18, a terminal control generating unit 18, and a terminal control unit 20. In addition, the network control device 4 uses the IP address that is already set as known. In addition, with respect to the master node device 5, the IP address is set as known.

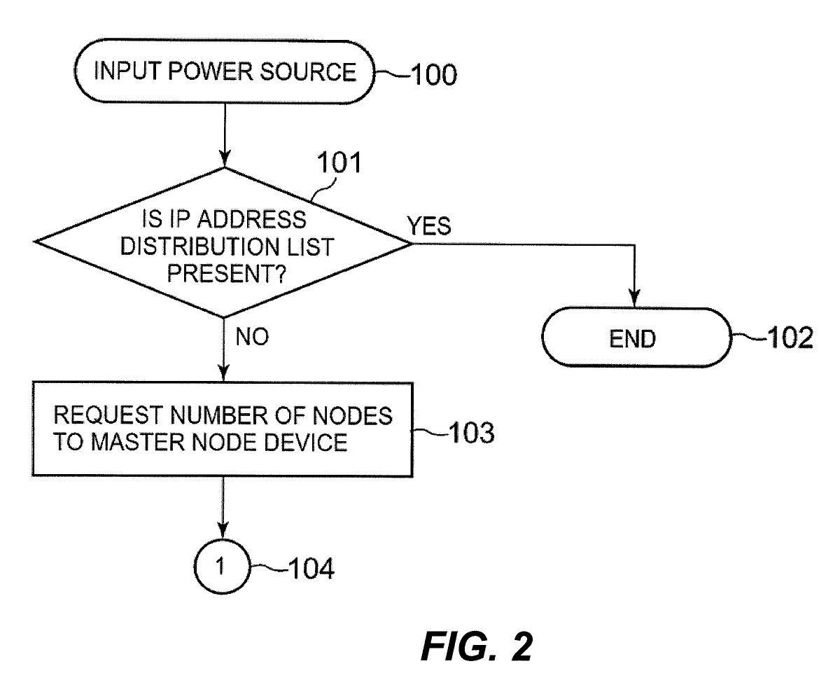

FIG. 2 is a flow chart showing an initial action at the time of address distribution of the network control device 4.

When the system is started up such as the power source is inputted, the network control device 4 confirms whether or not the IP address distribution list is present in the IP address extracting unit 15 in a step 101. In the case that the IP address distribution list is not present the processing is transmitted to a step 103 and the network control device 4 transmits the number of nodes request to the master node device 5, and then the processing is transmitted to a step 104. In the case that the IP address is present, the processing is transmitted to a step 102 and is finished.

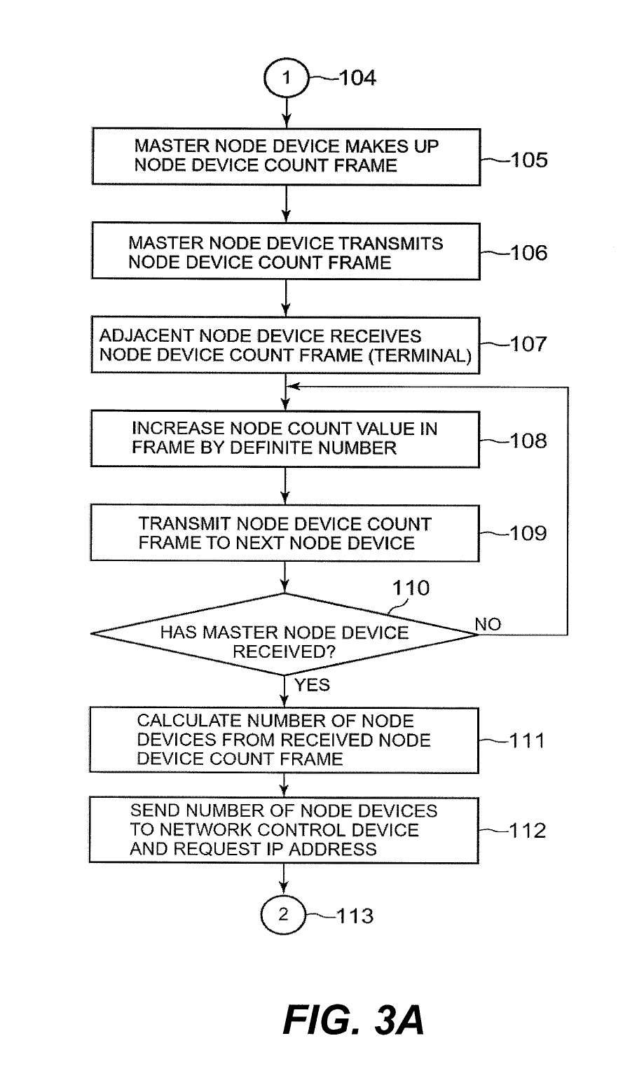

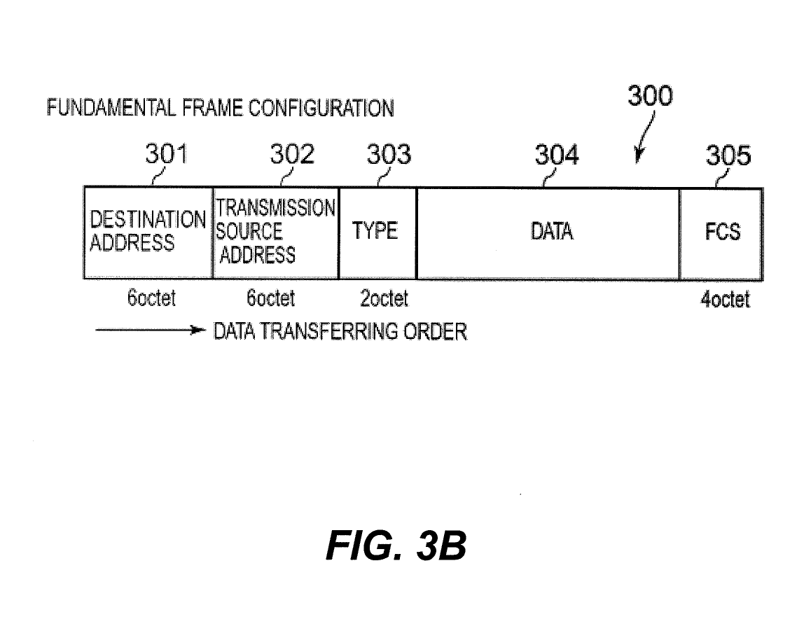

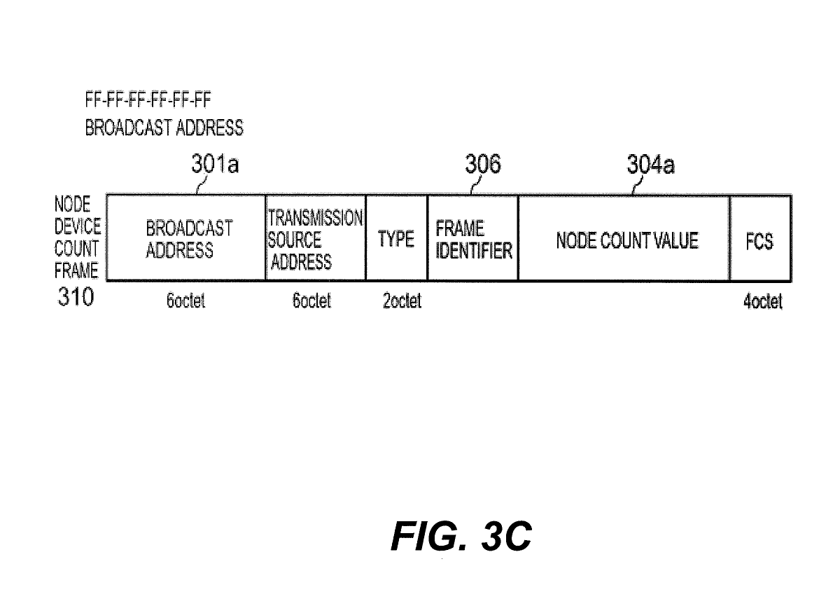

FIG. 3A shows a counting method of the node device 2 by the master node device 5.

The master node device 5 makes up a node device count frame from the request from the network control device 4 in a step 105 and inputs an initial value in the count value in the frame. FIG. 3B shows a fundamental frame configuration 300 of the data frame that is used in the present application. The fundamental frame configuration 300 includes a destination address 301, a transmission source address 302, a type 303 of the frame, data 304 of the object, an FCS (Frame Check Sequence) 305. FIG. 3C shows a configuration of a node device count frame 310. The node device count frame 310 can store a broadcast address 301a as the destination address. The broadcast address 301a is described by 6-octet as shown in the upper portion of FIG. 3C, and indicates that any devices can receive the relevant frame. In addition, the node device count frame 310 includes a frame identifier 306 and a node count value 304a as the data.

The initial value of the node count value 304a may be “0”, for example. The master node device 5 transmits the node device count frame in a step 106. The transmission direction may be any of a clockwise or counterclockwise direction, and the transmitting direction may be decided to one direction at any time. In a step 107, the adjacent node device 2 receives the node device count frame 310 and increases the count value 304a in the frame by a definite number. If “1” is increased, for example, the count value 304a in the frame becomes “1”. In addition, the node device does not transfer the frame to the other node devices, until the IP address is set. In a step 108, the node device transmits the node device count frame 310 in which the count value 304a is increased to the next adjacent node device. The processing is repeated till the master node device 5 receives the node device count frame 310. When the master node device 5 receives the node device count frame 310, the master node device 5 obtains by calculation the number of the nodes from the node device count frame 310 in a step 111. At the same time the master node device 5 transmits the obtained number of the nodes to the network control device, requests the IP address in a step 112.

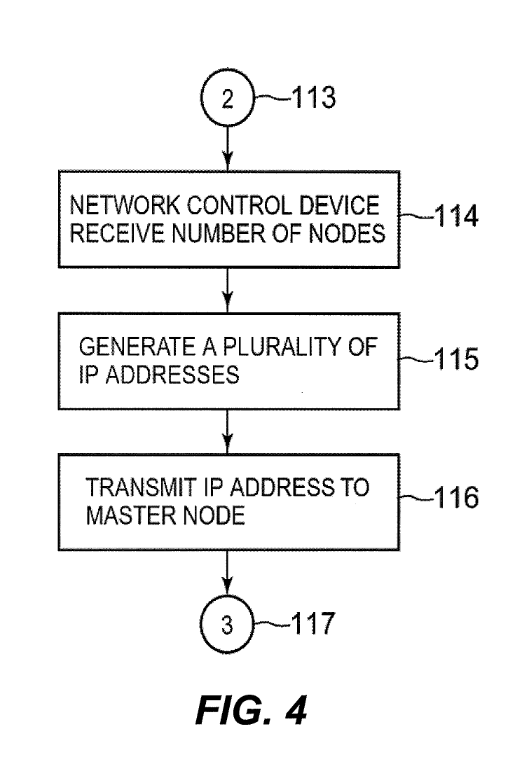

As shown in FIG. 4, when the network control device 4 receives the number of the nodes and the IP address request in a step 114, generates the IP addresses in a step 115. In this time, with respect to the IP addresses, the network control device 4 generates the IP addresses by the number of the node devices from a plurality of freely usable IP addresses which are previously prepared freely, and transmits the IP addresses to the master node device 5 in a step 116.

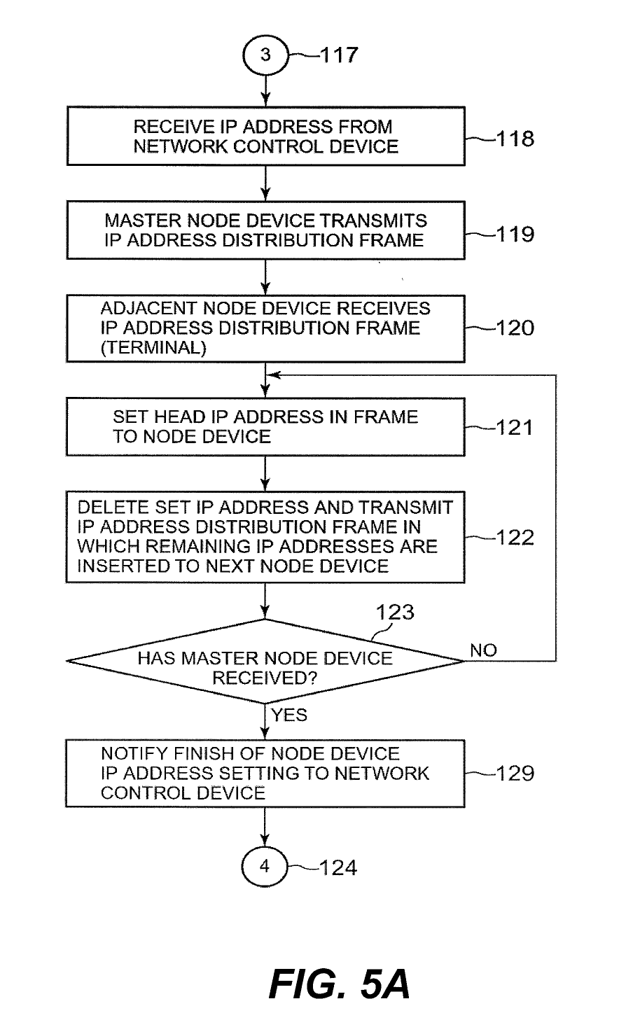

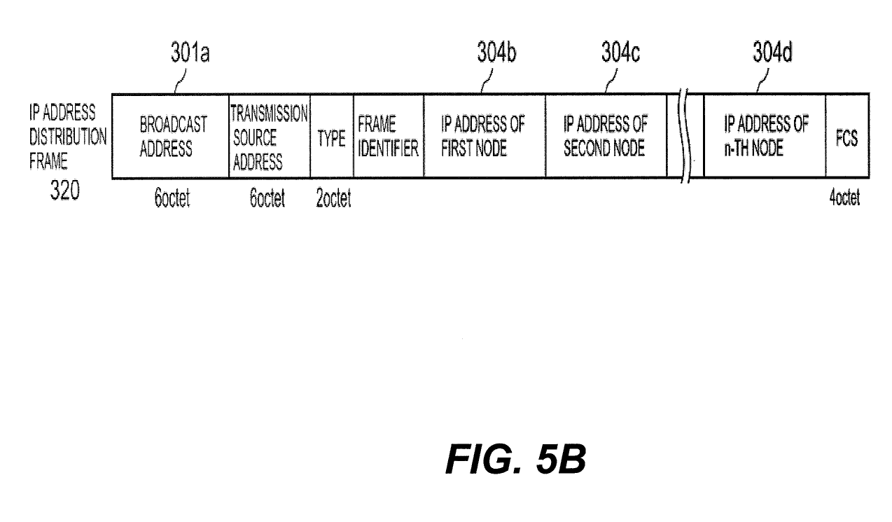

FIG. 5A shows a distribution method of the IP addresses to the node device 2. The master node device 5 receives the IP addresses from the network control device 4 in a step 118, and makes up an IP address distribution frame 320 in a step 119. FIG. 5B shows a configuration of the IP address distribution frame 320. The master node device 5 stores and transmits the IP addresses in such a manner that the order of the addresses of the nodes are correlated with the order of the node devices as shown in 304b˜304d of FIG. 5B, and the adjacent node device 2 receives the IP address distribution frame 320 in a step 120. In a step 121, the adjacent node device 2 sets the IP address 304b positioned at the head of the data portion 304 in the frame to the relevant node device, and deletes the set IP address from the IP address distribution frame and transmits the IP address distribution frame 320 to the next adjacent node device 2 in a step 122. By repeating the processing till the master node device 5 receives, it is possible to set the IP address individually to all the node devices 2. In addition, as the IP addresses are set in the adjacent node devices 2 in the order that is arranged in the frame 320, it is possible to identify the vehicle in which the node device 2 is installed, and also it is possible to correlate the installation position of the node device 2 with the IP address.

It was described in the above-description that with respect to the inserting order of the IP addresses which are inserted in the IP address distribution frame 320 to set the IP addresses, the IP addresses are inserted from the head of the data portion 304 in the frame in order, but a method may be used that the IP addresses are inserted from the bottom of the frame in order and the IP addresses are deleted also from the bottom at the time of setting.

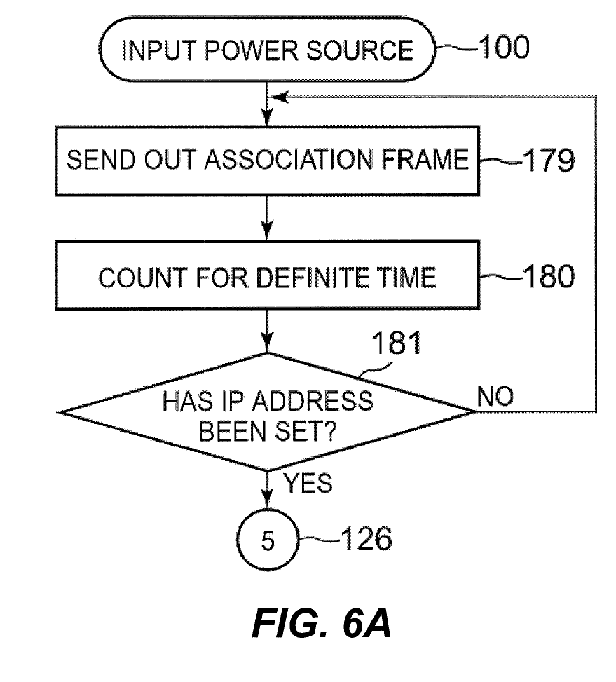

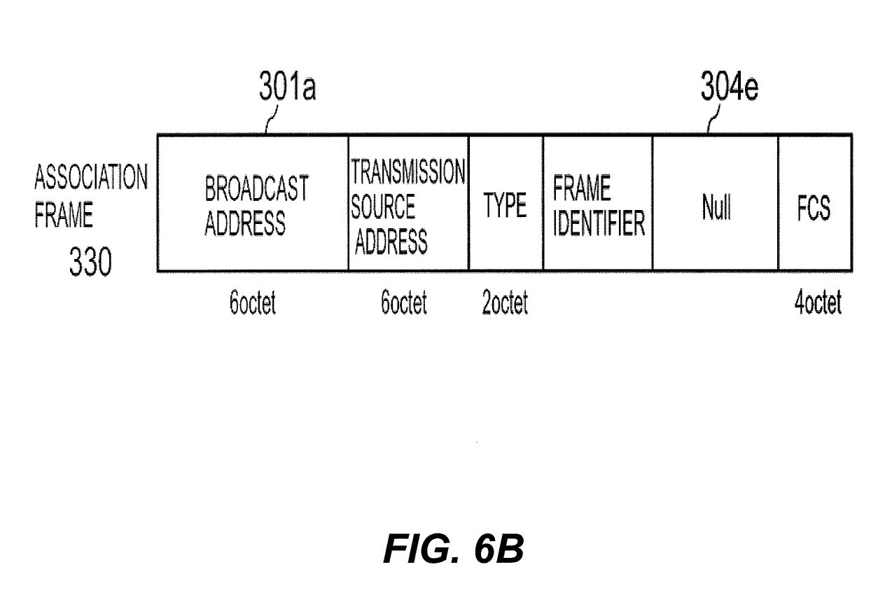

Next, a procedure to set the IP address to the terminal equipment 3 will be described. FIG. 6A shows an action of the terminal equipment 3 at the time of inputting the power source. After the step 100 to input the power source, the terminal equipment 3 transmits an association frame 330 in a step 179. FIG. 6B shows a configuration of the association frame 330. The association frame 330 includes the broadcast address 301a as the destination address and a Null 304e as the data. After a waiting time to count for a definite time in a step 180, the terminal equipment 3 confirms whether the IP address is set in an IP address setting unit 21 in a step 181. In the case that the IP address is not set, the terminal equipment sends out the association frame 330 again, and in the case that the IP address is set, finishes sending out the association frame 330. With respect to the waiting time, a method may be used in which the waiting time is changed in a random manner by generating random number.

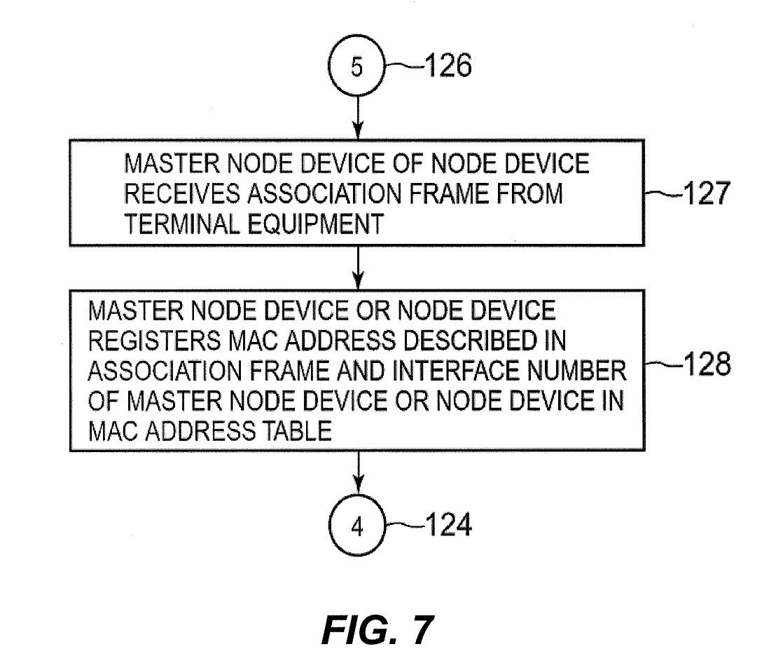

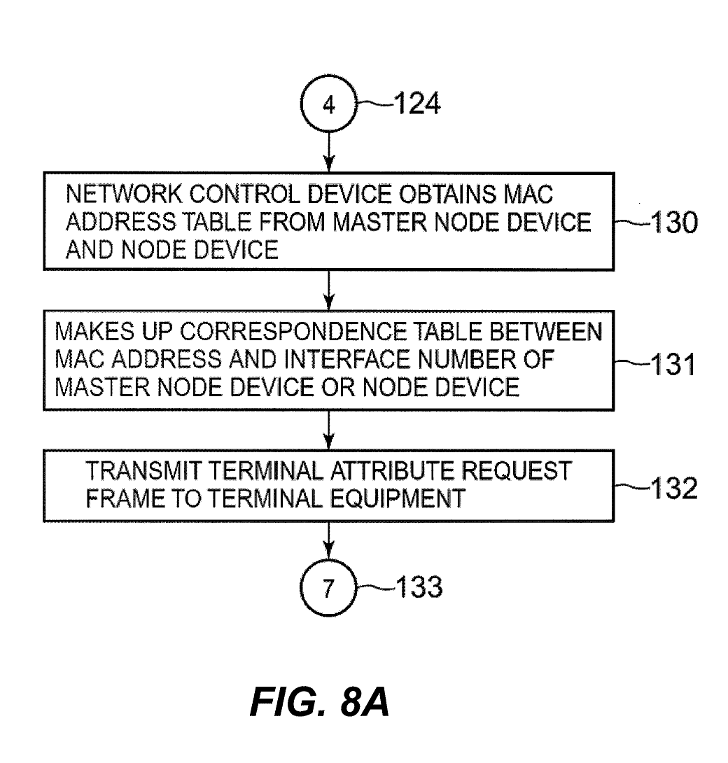

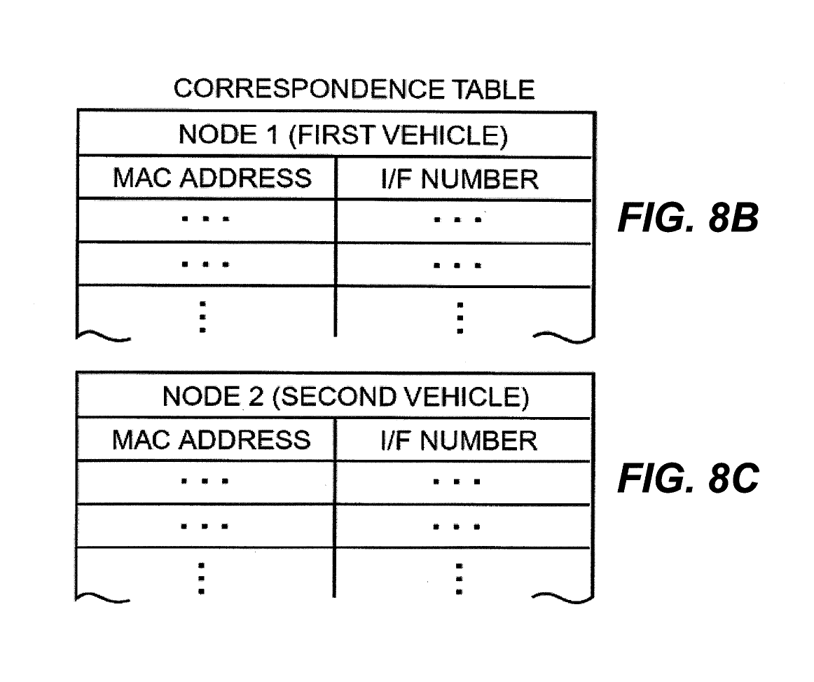

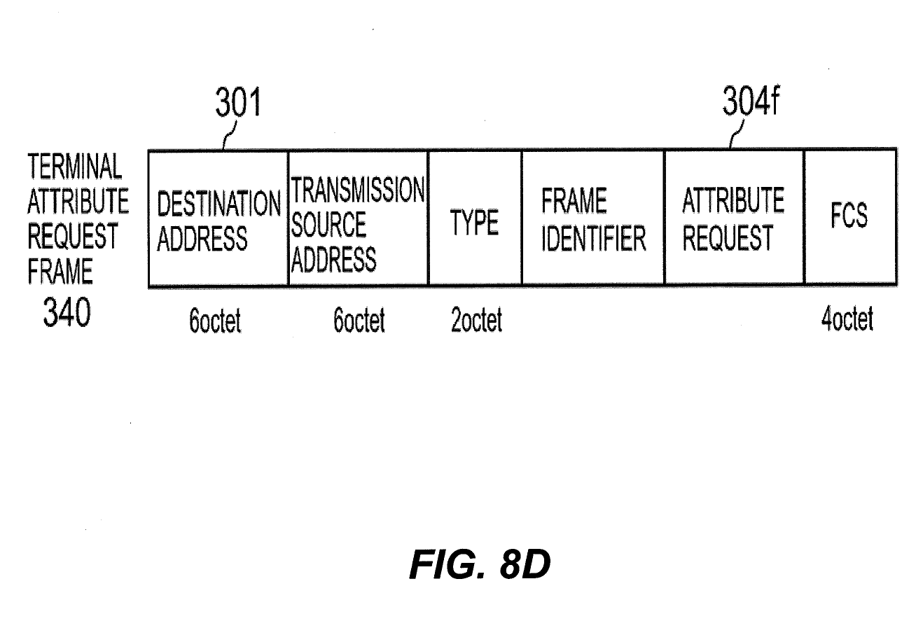

As shown in FIG. 7, the node device 2 and the master node device 5 receive the association frame 330 in a step 127, and in a step 128 register a MAC address of the connected terminal equipment 3 and its connected interface number on the MAC address tables of the node device 2 and the master node device 5, respectively. The transmission has become possible between the node device 2 and the master node device 5 and the network control device 4, as the IP address is already set as described above. By this, the network control device 4 collects the MAC address tables from the node device 2 and the master node device 5 in a step 130 shown in FIG. 8A. By this, the network control device 4 makes up a correspondence table shown in FIG. 8B to correlate the MAC addresses of the terminal equipment 3 connected to the node device 2 and the master node device 4 with the interface numbers in the node device 2 and the master node device 5 in a step 131. In a step 132, the network control device 4 transmits to the terminal equipment 3 a terminal attribute request frame 340 to request terminal attribute data indicating the attribute (driving device, braking device and so on) of the terminal equipment 3 to the terminal equipment 3, using the MAP address of the terminal equipment 3 obtained as described above. FIG. 8C shows a configuration of the terminal attribute request frame 340. The MAC address of the terminal equipment 3 is stored as the destination address 301, and an attribute request 304f is store as the data.

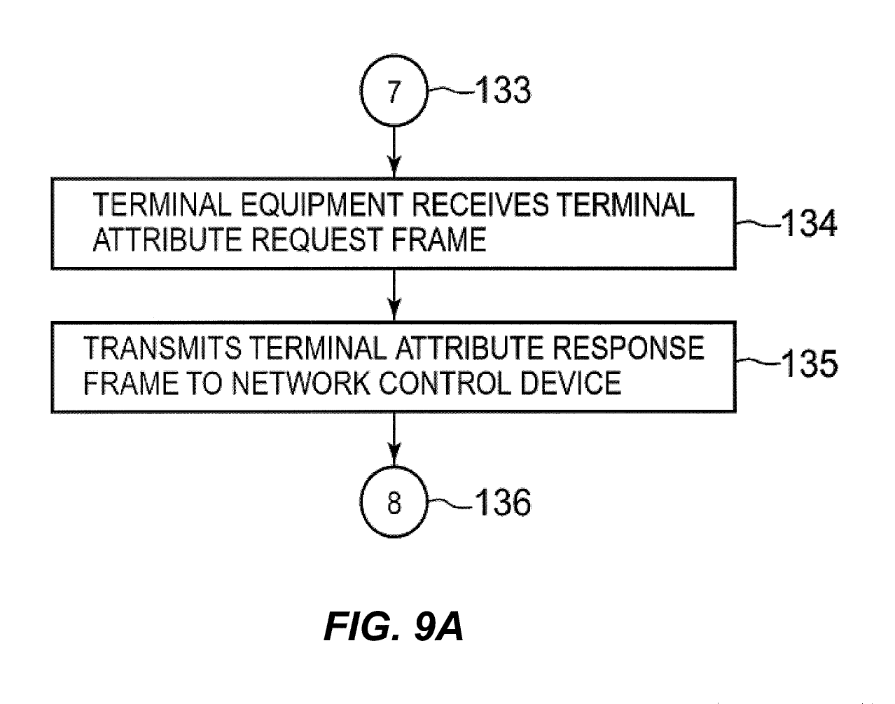

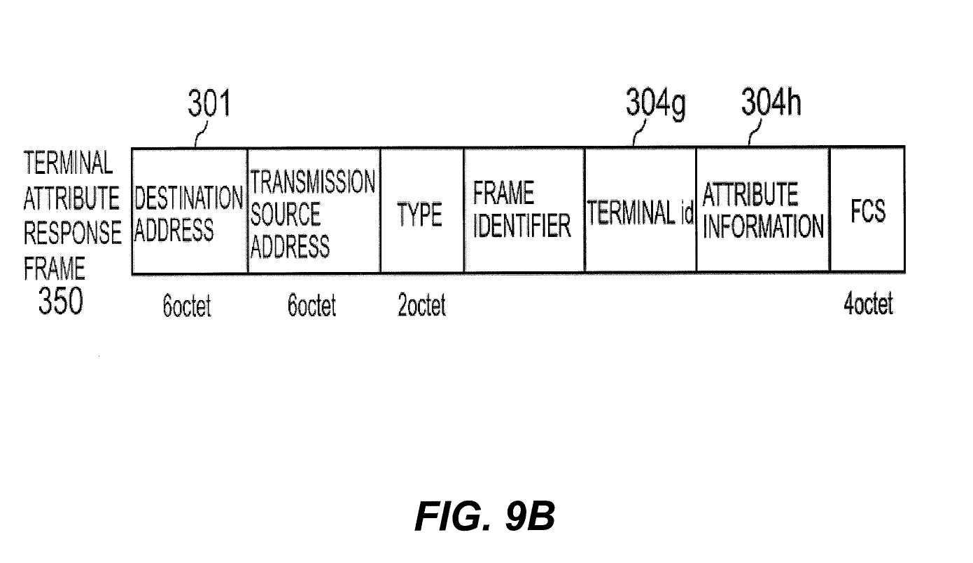

As shown in FIG. 9A, the terminal equipment 3 which received the terminal attribute request frame 340 in a step 134 sends back a terminal attribute response frame 350 to store the content of an own terminal attribute memory unit 22 to the network control device 4 in a step 135. FIG. 9B shows a configuration of the terminal attribute response frame 350. As the destination address 301 the IP address of the network control device 4 is stored, and as the data 304 a terminal id 304g and an attribute information 304h of the relevant terminal are stored.

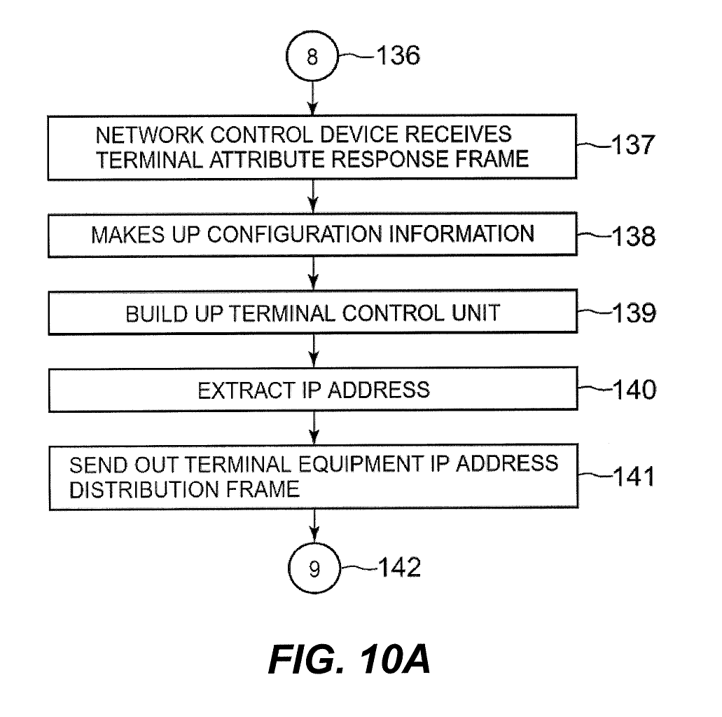

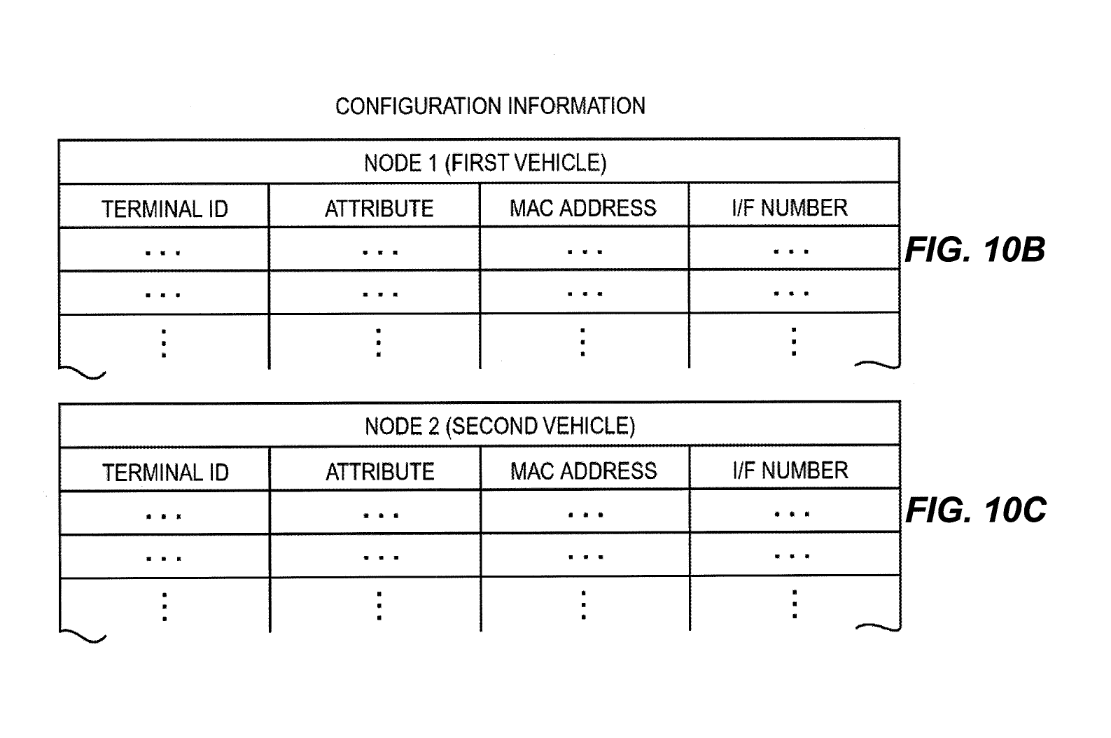

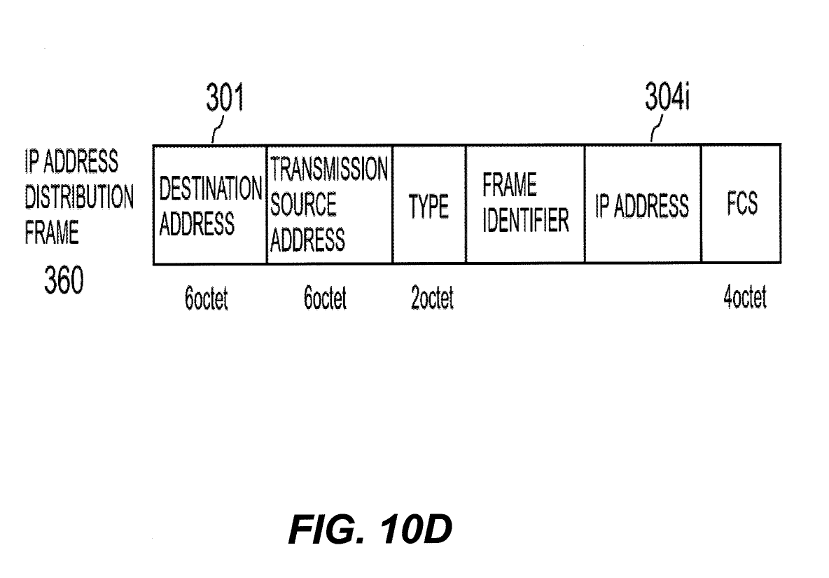

As shown in FIG. 10A, the network control device 4, using the terminal attribute information that is received in a step 137, makes up a configuration information shown in FIG. 10B in a step 138. In the configuration information, the ID of the terminal equipment connected to each vehicle, the attribute information, the MAC address, the position of the node device 2 or the master node device 5 connected to the relevant terminal equipment (vehicle number), and a terminal equipment interface number of the node device 2 or the master node device 5 are correlated with.

The network control device 4 builds up the terminal control unit 20 so as to serve in the train in a step 139 from the configuration information. The terminal control unit 20 may be an operation program, an interface conversion program so as to be connected to the terminal equipment 3 required for the necessary service of the train and required for doing the service, or a service program itself. In the case of the operation program, for example, the information that there are two vehicle driving units in the formation and the braking device is provided by one for each vehicle and so on can be obtained from the configuration information as shown in FIG. 10B. Accordingly, the operation program is built up based on the configuration information of the vehicles. In addition, the building up of the terminal control unit includes the processing to write an actual address into the address in the program such as the operation program, various types of service programs of the train, and the ATO program in the case of the ATO vehicle, based on the configuration information. In a step 140, the IP address is extracted so as to correlate with the MAC address of the terminal equipment that becomes the object to be controlled of the terminal control device 20. In this IP address extraction, one IP address is extracted from a plurality of freely usable IP addresses which are previously prepared.

The network control device 4 stores the extracted IP address in a terminal equipment IP address distribution frame 360 so as to distribute the IP address extracted as described above to the corresponding terminal equipment 3 and transmits it to the terminal equipment 3 in a step 141. FIG. 10C shows a configuration of the terminal equipment IP address distribution frame 360. As the destination address 301 the MAC address of the terminal equipment 3 and as the data an IP address 304i of the terminal equipment 3 are included.

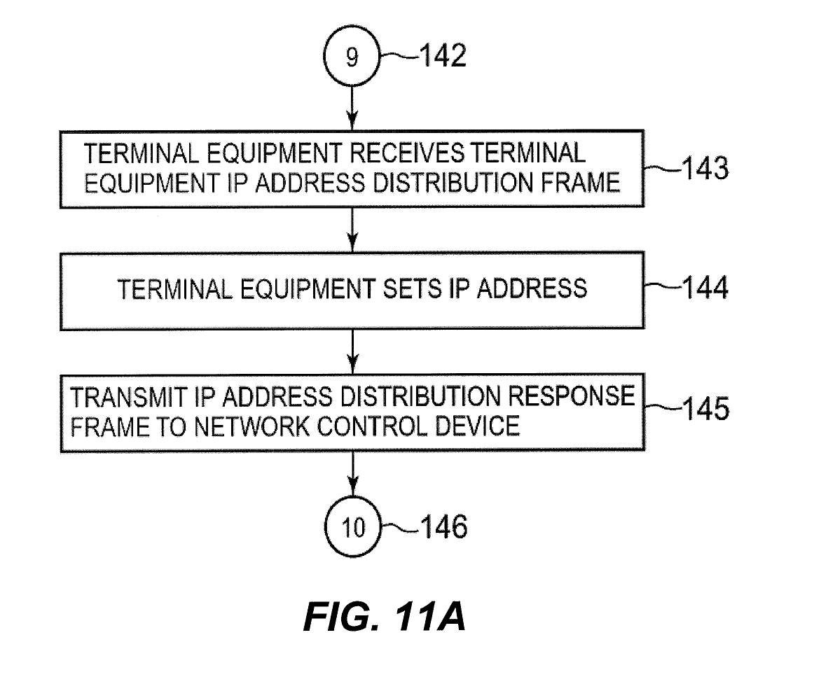

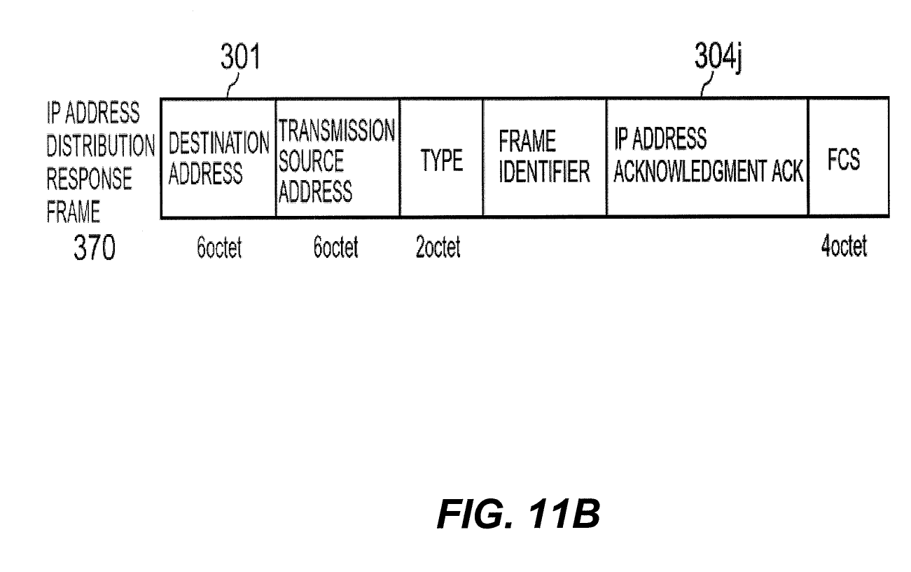

As shown in FIG. 11A, the terminal equipment 3 receives the terminal equipment IP address distribution frame 360 in a step 143, and sets the designated IP address 304i to the own terminal equipment if the MAC address coincides in a step 144. After setting, the terminal equipment 3 sends back a terminal equipment IP address distribution response frame 370 to the transmission source in a step 145. FIG. 11B shows a configuration of the IP address distribution response frame 370. The IP address distribution response frame 370 includes as the destination address 301 the MAC address of the network control device 4 and as the data an IP address acknowledgment ACK 304j.

The network control device receives the terminal equipment IP address distribution response frame 370 in a step 147, and finishes the IP address distribution to the terminal equipment.

As is constructed like this scheme, it is possible to set automatically the IP addresses required for the service to all the terminal equipment 3. Accordingly, the mistake due to the manual setting of the IP address to the terminal equipment 3 can be eliminated. In addition, as the terminal control unit 20 is constructed and the corresponding IP address is set, according to the formation, such as the change in the number of the vehicles, the IP address can be distributed and set to the terminal equipment which becomes the object to be controlled, without changing the IP address in the terminal control unit 20.

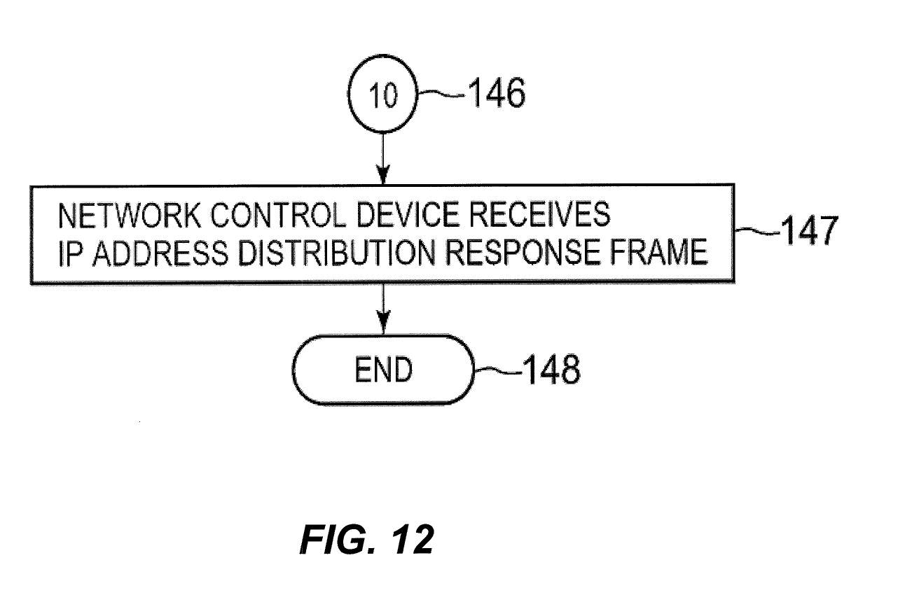

In addition, the encircled numbers described in the flow charts from FIG. 2 to FIG. 12 indicate that the flow is connected between the same encircled numbers.

### Second Embodiment

Next, a modification of a distribution method of the IP address to the node device 2 will be described as a second embodiment.

As a distribution method of IP address to the node device 2, in place of the method in which the number of the node devices 2 is obtained, and then the IP addresses are distributed in order as described above, a method will be described in which a node number is given to the node device 2, and the corresponding IP address is distributed to the node device 2 by directly designating the node number.

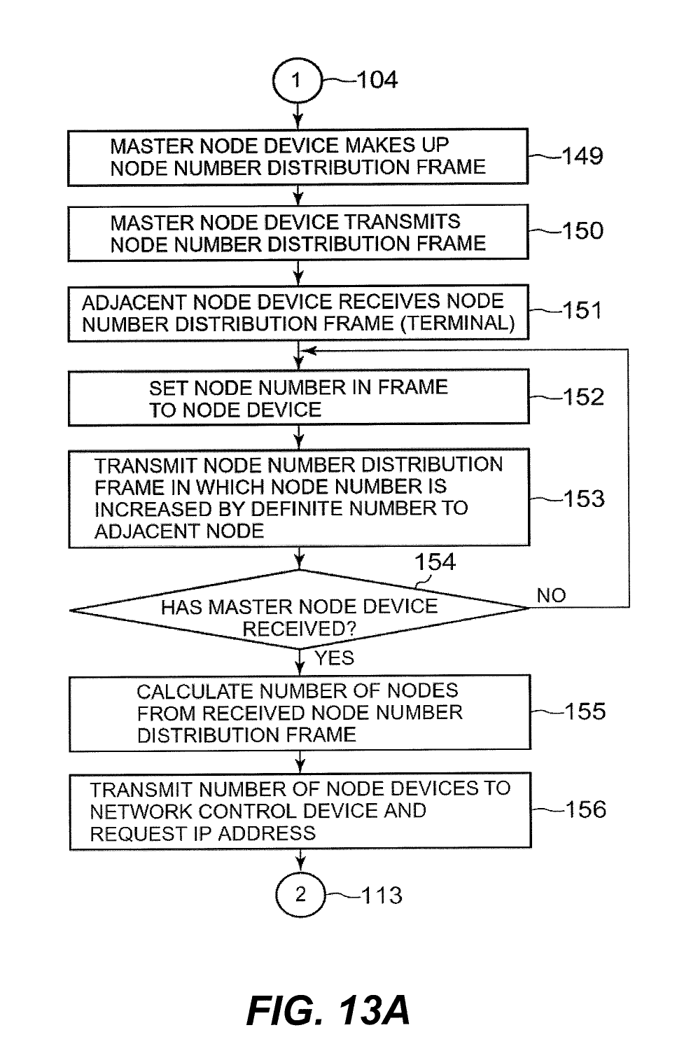

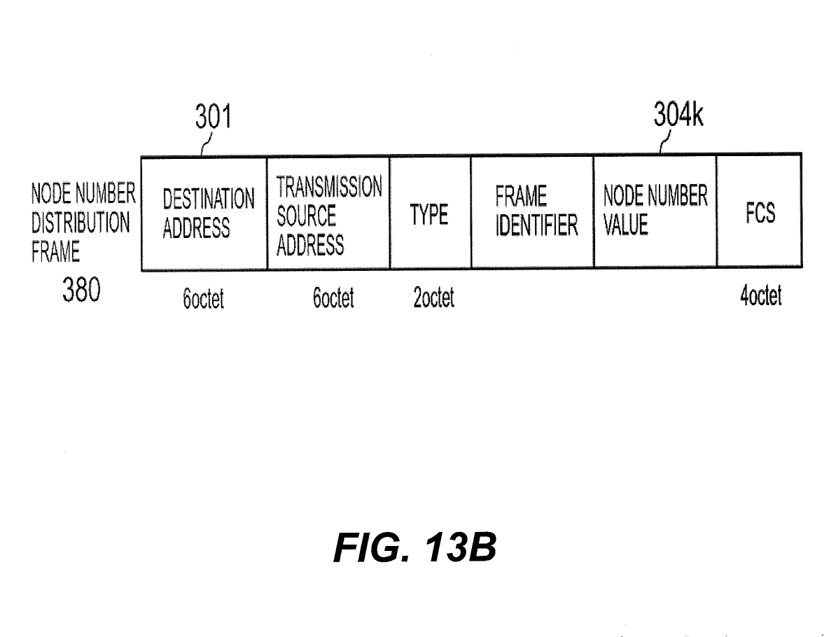

FIG. 13A is a flow chart to replace FIG. 3A, and it is shown that an encircled number 1 is connected to the encircled number 1 in the flow chart of FIG. 2, and an encircled number 2 is connected to the encircled number 2 in the flow chart of FIG. 4.

The master node device 5, which received the request for the number of the nodes, makes up a node number distribution frame 380 in a step 149. FIG. 13B shows a configuration of the node number distribution frame 380. As the destination address 301 the above-described broadcast address is set, and as the data an initial value 304k of the node number is set. The node number distribution frame 380 is transmitted to the adjacent node device in a step 150. In this time, the transmission direction of the node number distribution frame 380 may be any of a clockwise or counterclockwise direction.

The node device 2 which received the node number distribution frame 380 sets the node number which is set in the node number distribution frame to the own node device in a step 152, increases the node number in the node number distribution frame by a definite number, and transmits it to the next node device 2. The processing is repeated till the master node device 5 receives it. In a step 155, the master node device 5 calculates the number of the node devices from an initial value and the increased value of the node number of the received node number distribution frame, and transmits the number of the node devices to the network control device 4 in a step 156.

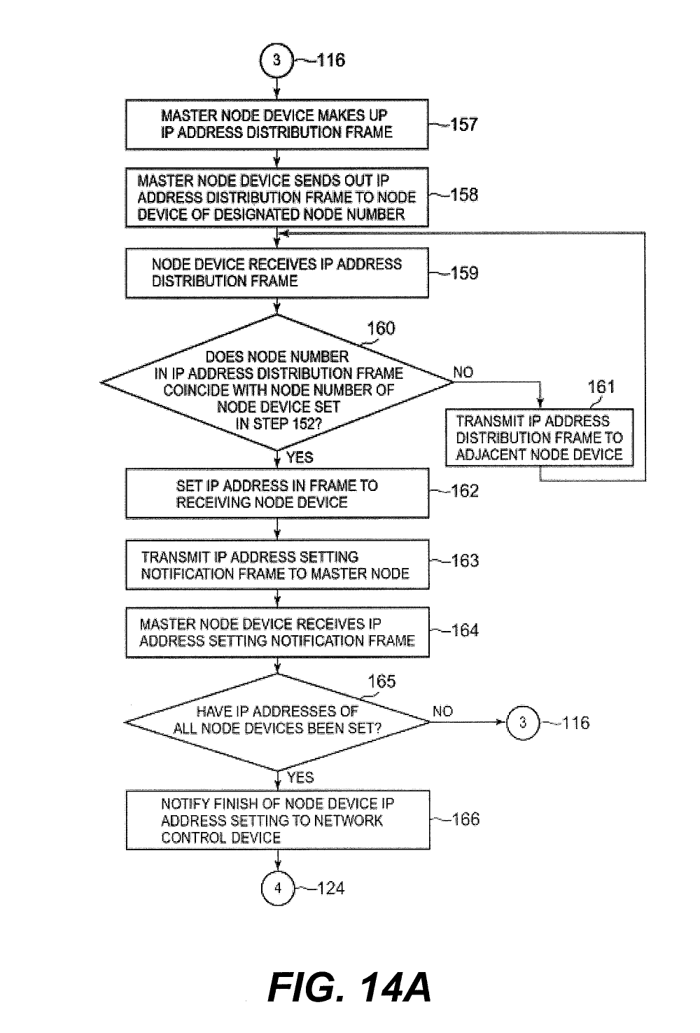

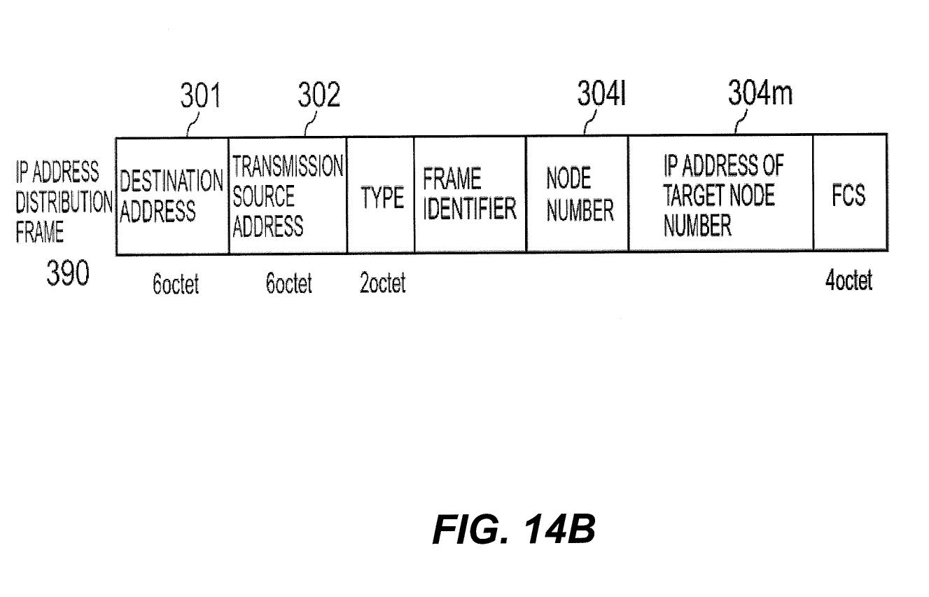

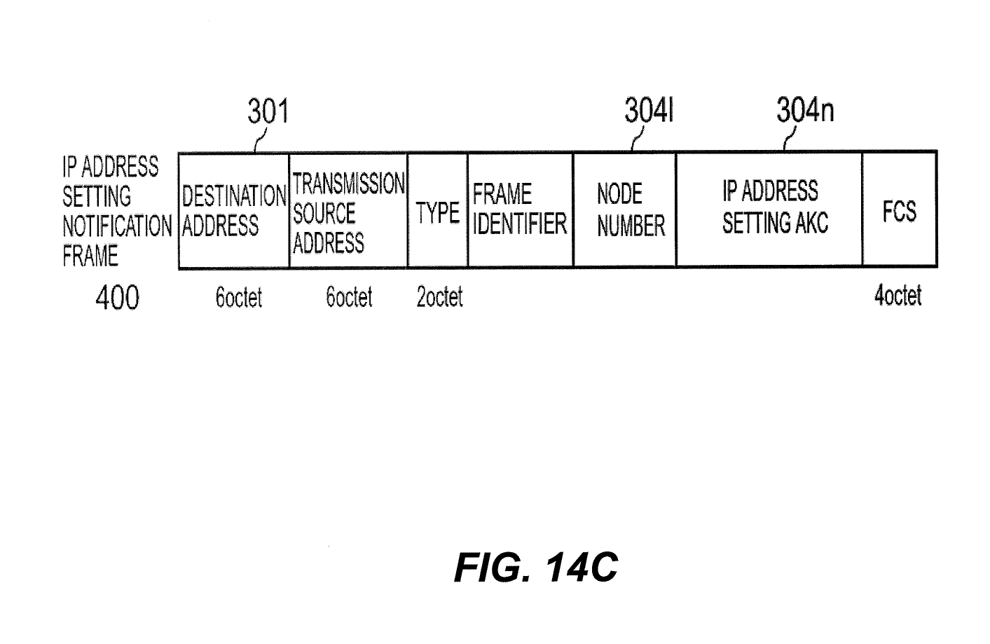

FIG. 14A is a flow chart to replace FIG. 5A, and it is shown that an encircled number 3 is connected to the encircled number 3 in FIG. 4, and an encircled number 4 is connected to the encircled number 4 in FIG. 8A.

The master node device 5 which received the IP address to be distributed to the node device 2 makes up an IP address distribution frame 390 in a step 157, and transmits the IP address distribution frame to the node device 2 having the node number corresponding to the above-described IP address in a step 158. FIG. 14B is a diagram showing a configuration of the IP address distribution frame 390. The broadcast address is set as the destination address 301, the IP address of the master node device 5 is set as the transmission source address 302, and a node number 304l and an IP address 304m corresponding to the relevant node number are set as the data.

The node device 2 sets the IP address in the IP address distribution frame to the own node device in the case that the node number described in the IP address distribution frame 390 coincides with the node number of the own node device in a step 162. The node device 2, which has set the IP address, transmits an IP address setting notification frame 400 to the master node device 5 in a step 163. FIG. 14C is a diagram showing a configuration of the IP address setting notification frame 400. The MAC address (the transmission source address of FIG. 14B) of the master node device 5 is set as the destination address 301, and the node number 304l of the own node device and an IP address setting AKC 304n are set as the data.

When the master node device 5 receives the IP address setting notification frame, finishes the setting of the IP address to one node device. The master node device 5 executes this to all the node devices within the network, and when the setting of the IP addresses to all the node devices 2 is finished, notifies that to the network control device 4 in a step 166.

As is constructed like this scheme, it is possible to correlate the installation position of the node device 2 with the IP address.

### Third Embodiment

As a method to obtain the attribute of the terminal equipment 3, there is a case in which it is more advantageous in the development of the equipment to obtain the attribute by the processing in the further upper layer, in addition to a method to obtain in the data link layer. Hereinafter, a modification of an attribute obtaining method will be described as a third embodiment.

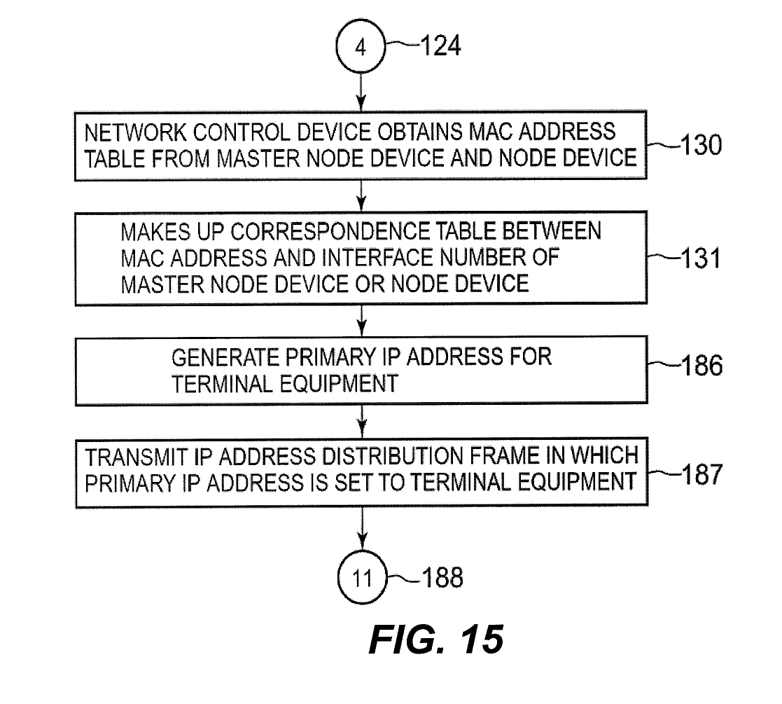

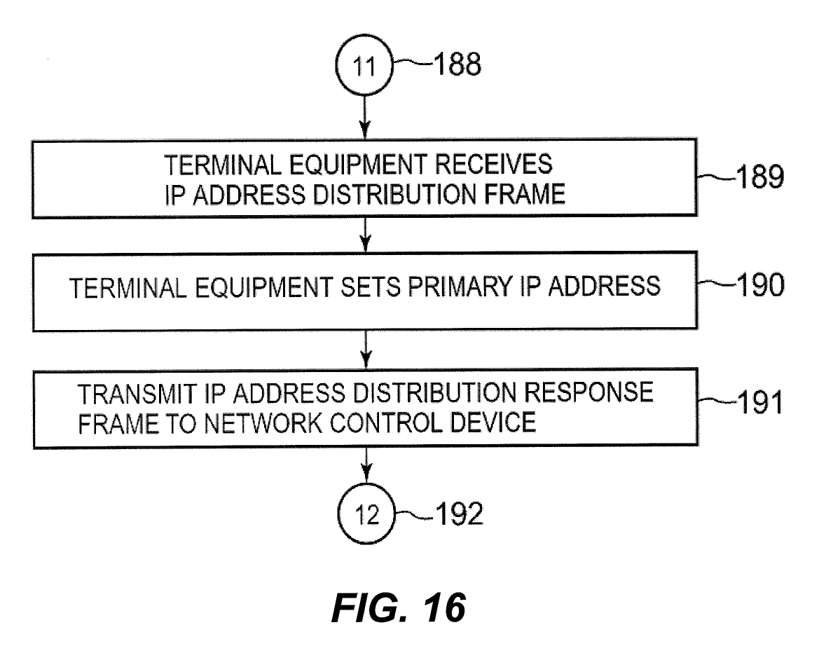

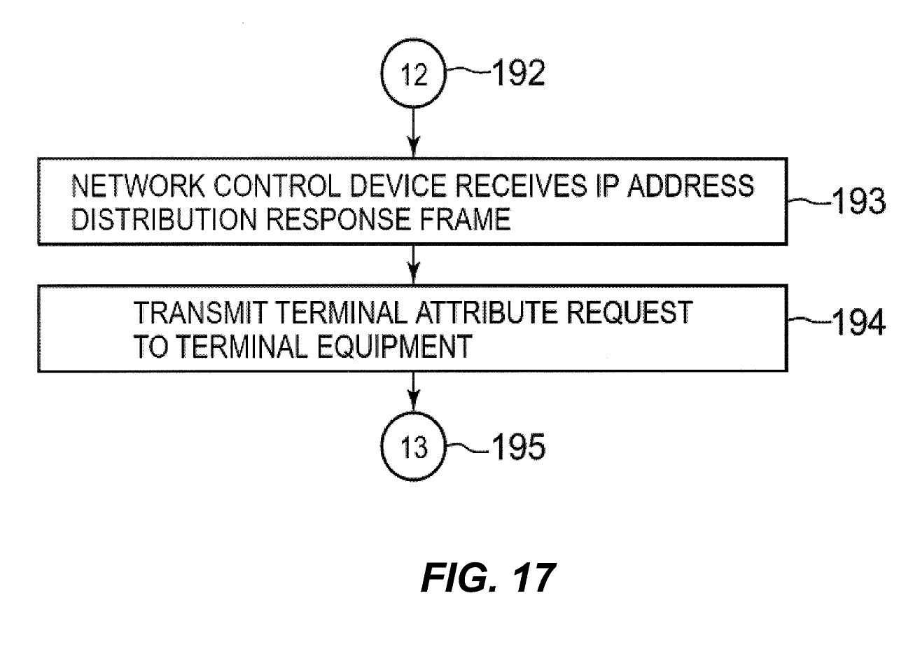

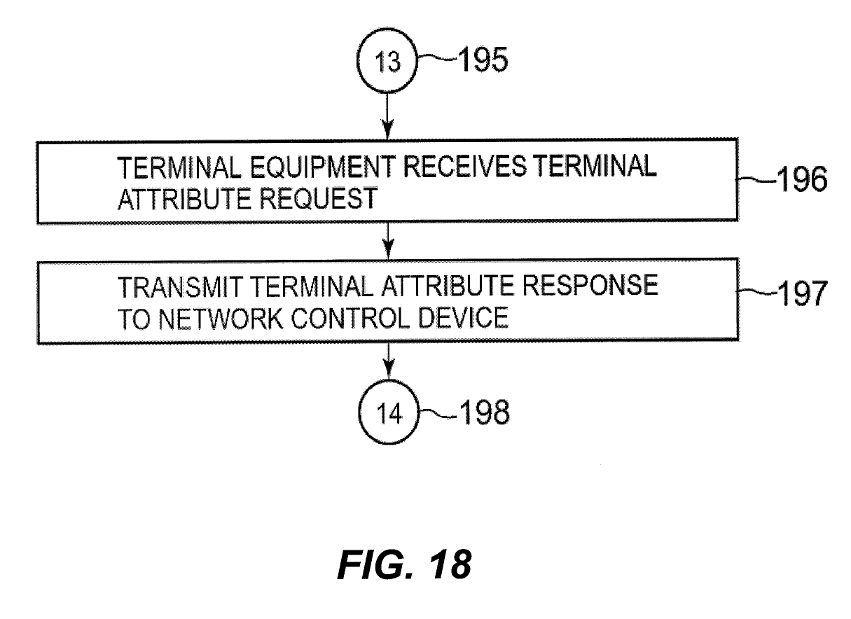

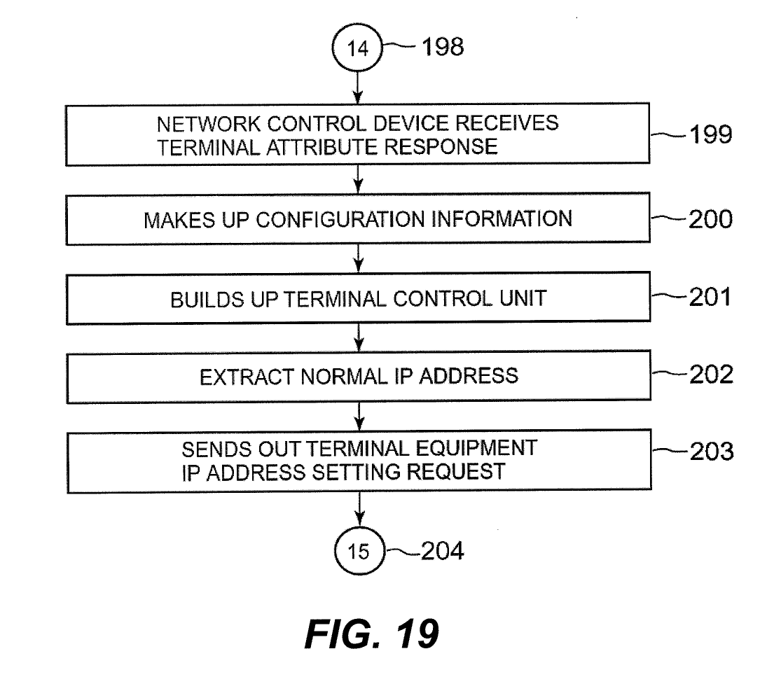

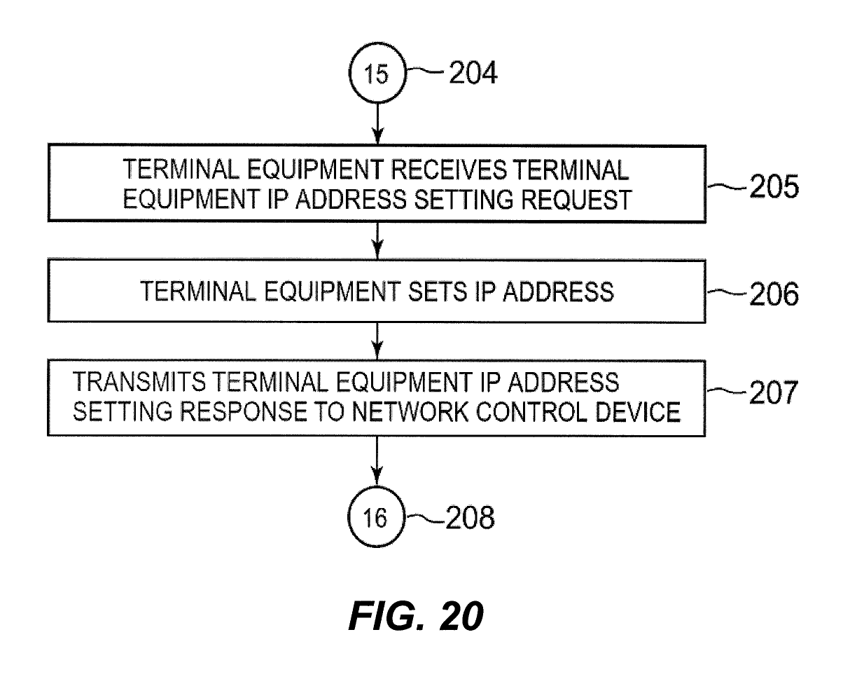

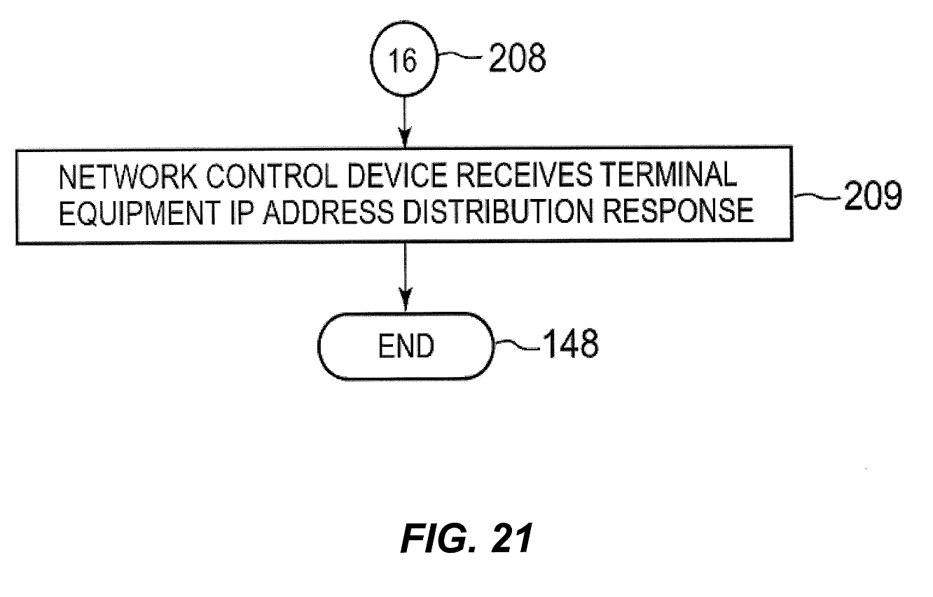

The flow charts thereof are shown in FIG. 15 through FIG. 20. It is shown that an encircled number 4 is connected to the encircled number 4 in FIG. 5A or FIG. 14A, and the same encircled number in each drawing indicates that the flow is connected. FIG. 15 shows a method in which the network control device 4 generates a primary IP address from the obtained MAC address table in which the MAC address of the terminal and the terminal interface number of the node device 2 and the master node device 5 are described, and distributes it to the terminal equipment. FIG. 16 shows a method in which the terminal equipment sets the primary IP address. FIG. 17 shows a method in which the network control device 4 transmits the terminal attribute request. FIG. 18 shows a method in which the terminal equipment 3 receives the terminal attribute request and transmits the terminal attribute response in which the terminal attribute data is described to the network control device. FIG. 19 shows a method in which the network control device builds up the configuration information, extracts the regular IP address for the terminal equipment 3, and transmits the IP address setting request so as to set the extracted IP address to the terminal equipment 3. FIG. 20 shows a method in which the terminal equipment 3 receives the IP address setting request and set the distributed regular IP address again. FIG. 21 shows that the network control device receives the terminal equipment IP address distribution response and finishes the distribution of the IP address.

As these methods are performed, it is possible to distribute the IP address that is used in the terminal control unit 20 to the terminal equipment 3.

### Fourth Embodiment

In the present embodiment, means is provided for each of the node devices and the master node device to record configuration information (the configuration information under the control of the node device) to describe the relation of the MAC address, the attribute information, the terminal interface number and the terminal device (terminal device id) with respect to the terminal equipment under the control of the node devices and the master node device (that is, connected to each node device). By using the configuration information made up by these means, the distribution time of the IP address can be made short at the time of starting up to input the power source and at the time of handling in changing the connection of the vehicles.

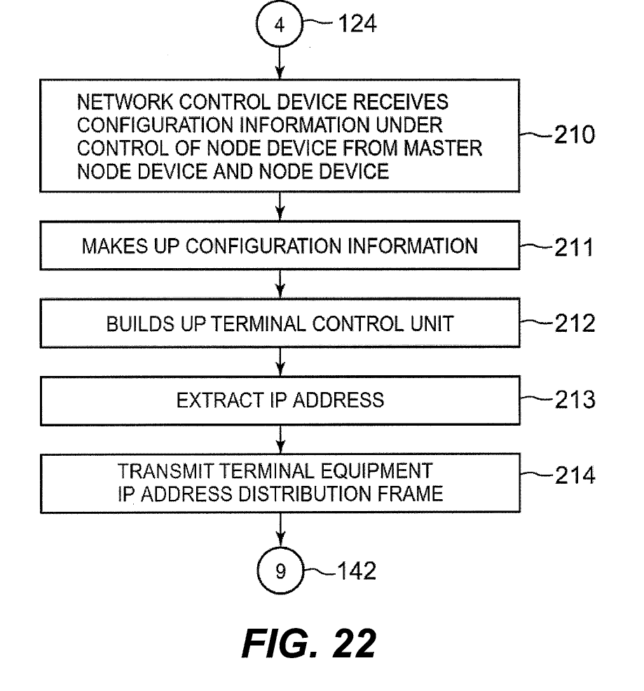

FIG. 22 shows an IP address distribution method of the present embodiment.

It is shown that an encircled number 4 in FIG. 22 is connected to the encircled number 4 in FIG. 5A or FIG. 7, and an encircled number 9 is connected to the encircled number 9 of FIG. 11A. Here, it is assumed that each of the node devices and the master node device has the above-described configuration information under the control of the node device. The network control device makes up the configuration information of the whole train from the configuration information under the control of the node device in a step 211, builds up the terminal control in a step 212, extracts the IP address in a step 213, and distributes the IP address to the terminal equipment in a step 214.

### Fifth Embodiment

By providing the means to store the type of structure indicating the type of the vehicle in the configuration information under the control of the node device, an operation to build up the terminal control unit 20 at the network control device 4 side can be simplified. Usually, the rail vehicles are composed of a plurality types of vehicles, such as a lead vehicle, a driving vehicle and a passenger car. As these vehicles have usually the same construction for the type, a type of structure is set for each type of the vehicle. A sub terminal control (control program module provided for each vehicle type) corresponding to the above-described type of structure is stored in a sub terminal control memory unit of the network control unit 4, and the network control unit 4 extracts the necessary sub terminal control from the sub terminal control memory unit, based on the type of structure obtained from the node device 2 or the master node device 5. The network control unit 4 can build up the terminal control unit 20 using the sub terminal control and can distribute the IP address to be used in the terminal control unit 20 to the terminal equipment 3.

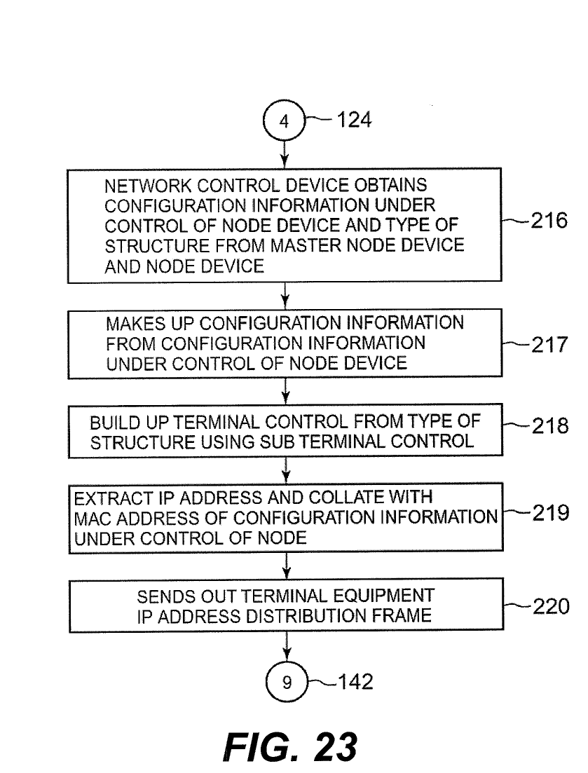

FIG. 23 shows an IP address distribution method of the present embodiment.

It is shown that an encircled number 4 in FIG. 23 is connected to the encircled number 4 in FIG. 5A or FIG. 7, and an encircled number 9 is connected to the encircled number 9 in FIG. 11A. The network control device makes up configuration information of the whole train from the configuration information under the control of the node device of each vehicle in a step 217. The network control device builds up the terminal control using the sub terminal control corresponding to the type of structure in a step 218, extracts the IP address and concurrently correlates the MAC address of the terminal equipment in the configuration information under the control of the node device with the IP address in a step 219, and distributes the IP address to the terminal equipment in a step 220.

In addition, various embodiments can be made by combining each of the above-described methods.

### Sixth Embodiment

In addition, as the network control device 4 has the configuration information in the vehicle and the IP address, it becomes possible to confirm the normality of each equipment. The normality confirmation processing will be described as a sixth embodiment.

The network control device 4 transmits a living confirmation frame to the terminal equipment that is registered in the configuration information. The terminal equipment receives the living confirmation frame, sends back a normal frame if the equipment is not abnormal, and sends back an abnormal frame in the case that the equipment is abnormal. In the case that the network control device 4 receives the abnormal frame or an answer is not sent back, judges and registers that the relevant terminal device is abnormal or notifies the abnormality. In addition, as the network control device 4 can find the vehicle position of the terminal equipment 3 and the terminal interface number of the node device 2 from the configuration information, it is possible to identify the position of the abnormal terminal equipment 3.

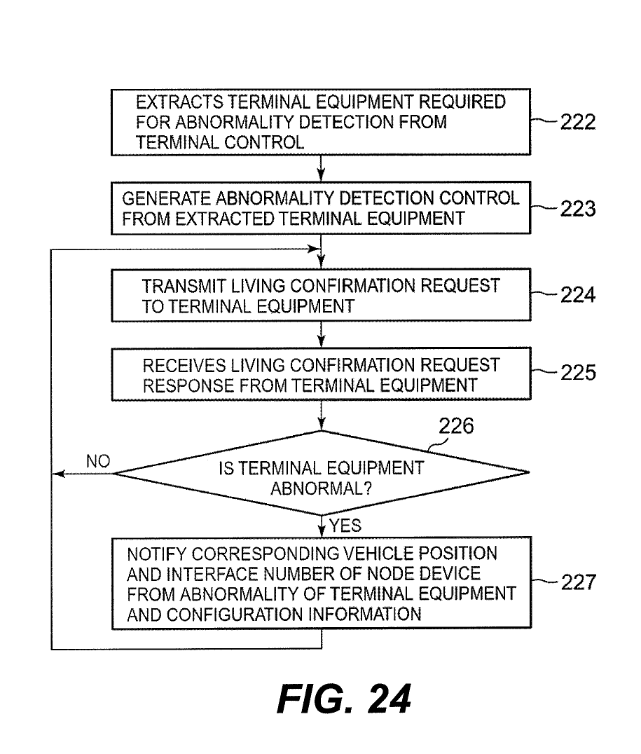

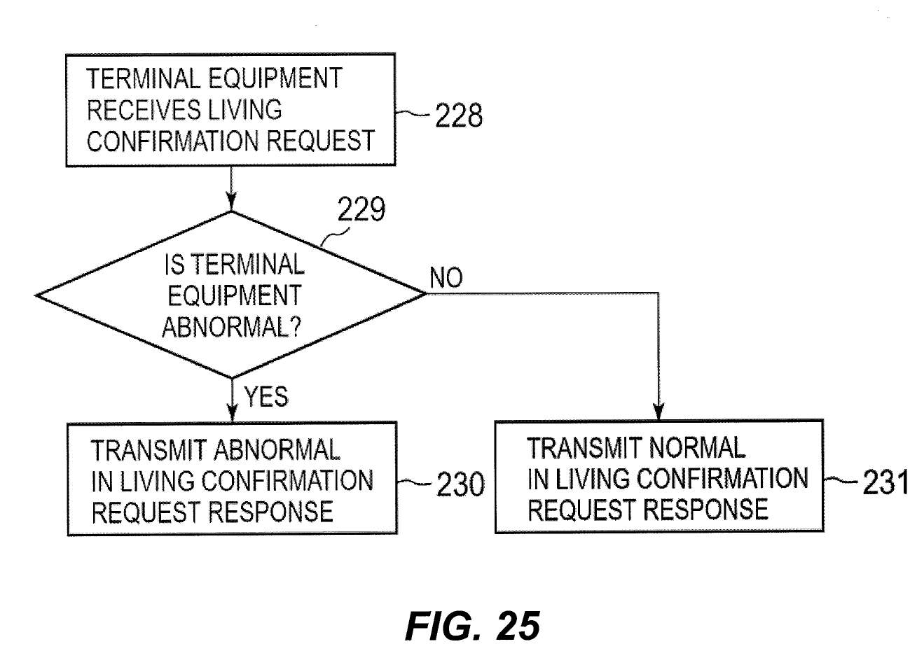

FIG. 24 and FIG. 25 show a method of the present embodiment. In FIG. 24, the network control device 4 extracts the terminal equipment and its associating information (terminal attribute, IP address, MAC address, node device interface number and so on) required for the abnormality detection from the terminal control unit 20 in a step 222, and generates an abnormality detection control in a step 223. That is, the network control device 4 writes the IP address, the MAC address, the node device interface number and so on, for example, in an abnormality detection control program based on the associating information. The network control device 4 transmits a living confirmation request to the terminal equipment in a step 224. In FIG. 25, the terminal equipment receives the living confirmation request in a step 228, and stores “normal” in a living confirmation request response if the own terminal equipment is normal, and sends it back in a step 231, and stores “abnormal” in the living confirmation request response if abnormal and sends it back in a step 230. In FIG. 24, the network control device receives the living confirmation request response in a step 225, and transmits the living confirmation request to the next terminal if normal. If abnormal, the network control device notifies an information including the vehicle implemented position of the corresponding terminal equipment and the terminal interface number of the node device in a step 227. This notification includes to display an alarm on the driver's platform, for example, or to notify the generation of the abnormality to the nearest station, or the like. As is structured like this scheme, it is possible to identify the position of the terminal equipment 3 that becomes abnormal.

### Seventh Embodiment

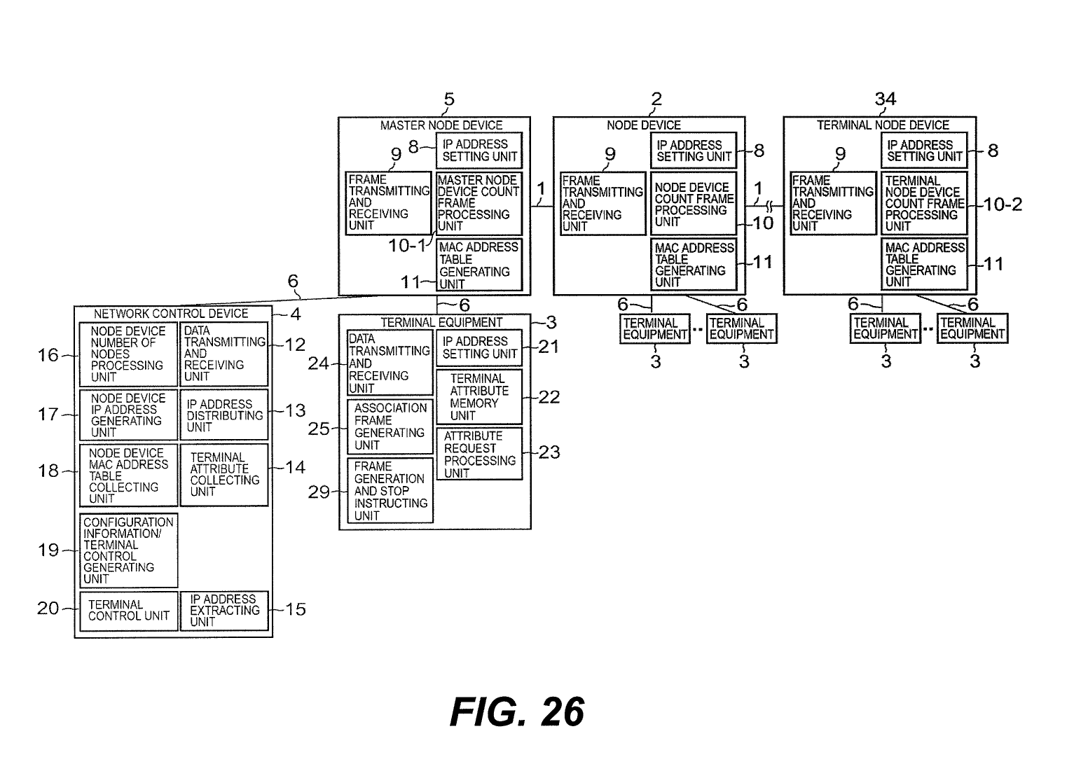

Until now, the description has been made by giving the actual examples in the ring type network configuration, but the same effect can be obtained in a bus type network. FIG. 26 shows a construction at the time the present disclosure is applied to the bus type network as a seventh embodiment.

In the bus type network, the difference is generated in the distribution method of the IP address to the node device. In the ring type, as the node device count frame or the node number distribution frame is transferred in one direction and for each of the nodes, returns surely to the master node device 5. But, in the bus type, a scheme so as to return it becomes necessary. For this reason, it is decided that one end of the bus is the master node device, and the other end is a terminal node device. When the terminal node device receives the node device count framed or the node number distribution frame, transfers it to the master node device. Here, the terminal node device identifies that the own node is the terminal node, as another node device is not connected backward from the own node.

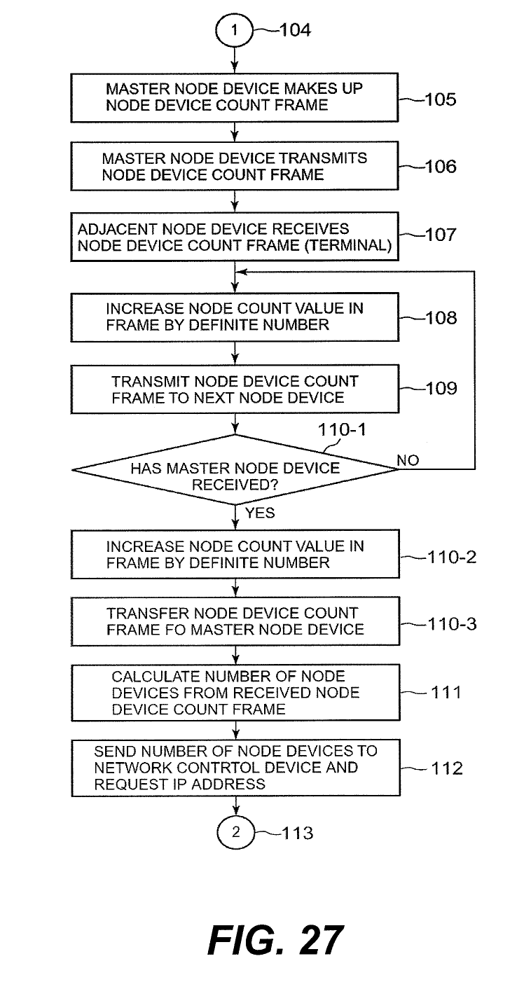

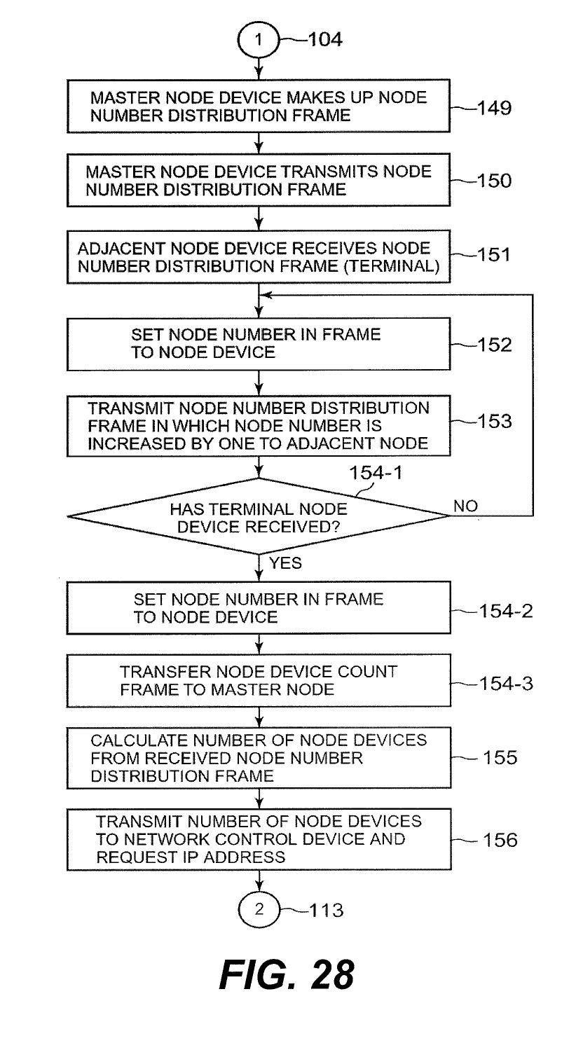

FIG. 27 shows a method of the seventh embodiment, and FIG. 28 shows its modification.

FIG. 27 becomes the method of the present embodiment by replacing FIG. 3A. It is shown that an encircled number 1 in FIG. 27 is connected to the encircled number 1 in FIG. 2, and an encircled number 2 in FIG. 27 is connected to the encircled number 2 in FIG. 4.

The difference from FIG. 3A is a point in which in the case that a terminal node device 34 receives the node device count frame, transfers the frame to the master node device 5 in steps 110-1, 111-2, 110-3. By describing the MAC address of the master node device in the frame to be transferred from the master node device 5, the terminal node device 34 can set this address in “destination address” of the node device count frame and can transfer it.

FIG. 28 becomes the modification of the seventh embodiment by replacing FIG. 13A, and it is shown that an encircled number 1 in FIG. 28 is connected to the encircled number 1 in FIG. 2, and an encircled number 2 is connected to the encircled number 2 in FIG. 4.

The difference from FIG. 13A is a point in which in the case that the terminal node device 34 receives the frame, transfers the frame to the master node device 5 in steps 154-1, 154-2, 154-3.

As is constructed by the method as described above, the present disclosure can be applied to the bus type network.

With respect to the bus type, various embodiments can be made by combining each of the above-described methods.

Next, devices to embody the above-described methods will be described in detail.

FIG. 1 is a first device construction according to the present disclosure, and shows a construction to embody an IP address distributing device using the ring type network.

That is, the first device construction of the IP address distributing device is a device characterized in that, in a loop type network composed of a network control device, a node device to perform route change by a MAC address, and a terminal equipment to be connected to it,

the node device has means for transmitting and receiving a frame to be transmitted to the node device in order, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting an association frame and means for stopping generation or transmission of the association frame,

the node device has means for generating a MAC address table that stores a transmission source MAC address of the inputted frame and an interface number, inputted in the frame,

the network control device has means to obtain the MAC address table, means for extracting the MAC address of the terminal equipment to be connected to the node device and a terminal interface number of the node device from the obtained MAC address table, and for requesting a terminal attribute for the terminal equipment using the MAC address of the terminal equipment,

the terminal equipment has means for transmitting the terminal attribute by the terminal attribute request, and

the network control device has means for generating a configuration information from the terminal attribute and the MAC address table, means for building up a terminal control, means for extracting an IP address to be set in the terminal equipment from the terminal control, and means for transmitting the extracted IP address to the corresponding terminal equipment, and

the terminal equipment has means for setting the received IP address to the own terminal equipment.

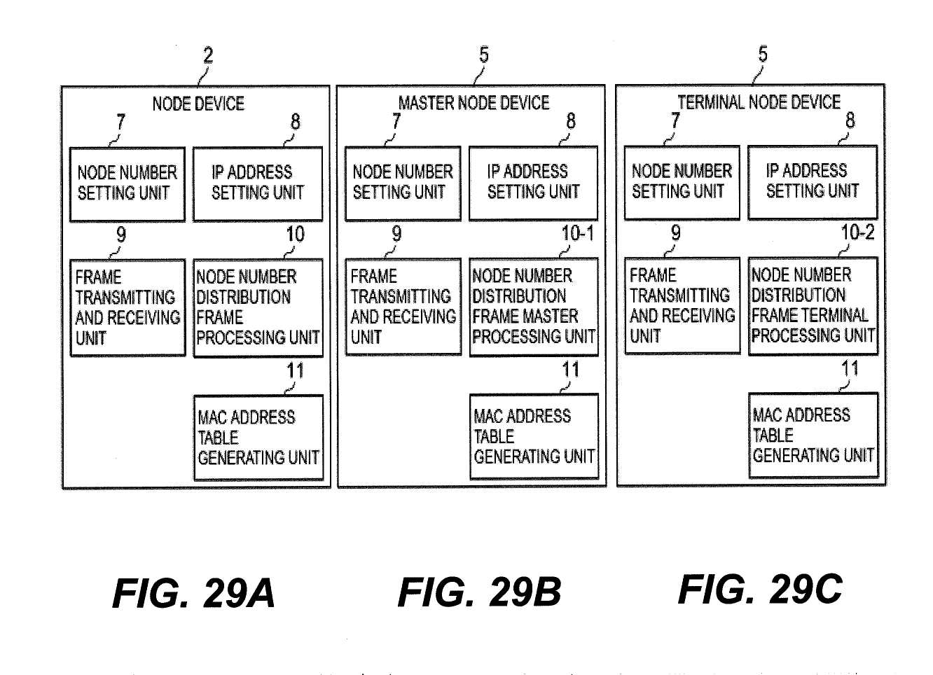

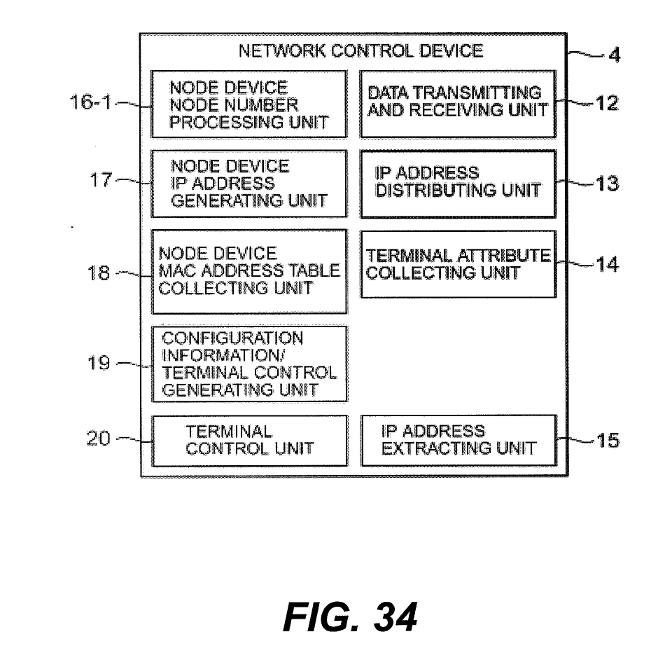

A second device construction according to the present disclosure can be achieved by changing the node device and the master node device in FIG. 1 to a node device and a master node device in FIG. 29 and by changing the network control device to a construction in FIG. 34.

That is, the second device construction of the IP address distributing device is a device characterized in that, a node number is described in the frame to be transmitted to the node device of the first device construction,

the node device which received the frame has means for setting the node number described in the frame to the own node device, for setting the number which is increased by a definite number from the node number of the received frame, and for sending it to the next adjacent node device, and means for obtaining the number of the node devices in the network from the node number of the frame which was transmitted to the first node device after transmitted to the node devices,

the network control device has means for describing the node number and IP address in the frame to transmit, and

the node device which received the frame in which the node number and the IP address are described has means for collating the node number described in the frame with the node number of the node device to set the IP address to the node device.

A third device construction according to the present disclosure can be achieved by changing the network control device in FIG. 1 to FIG. 35.

That is, the third device construction of the IP address distributing device is a device characterized in that, the network control device of the first device construction has means for allotting a primary IP address for the obtained MAC address of the terminal equipment and means for transmitting the primary IP address to the terminal equipment,

the terminal equipment has means for setting the IP address,

the network control device has means for requesting a terminal attribute to the terminal equipment using the primary IP address,

the terminal equipment has means for transmitting the terminal attribute by the terminal attribute request,

the network control device has means for generating a configuration information from the terminal attribute and the MAC address table, means for building up a terminal control, means for extracting the IP address to be set in the terminal equipment from the terminal control, and means for transmitting the extracted IP address to the corresponding terminal equipment using the primary IP address, and

the terminal equipment has means for setting the received IP address to the own terminal equipment.

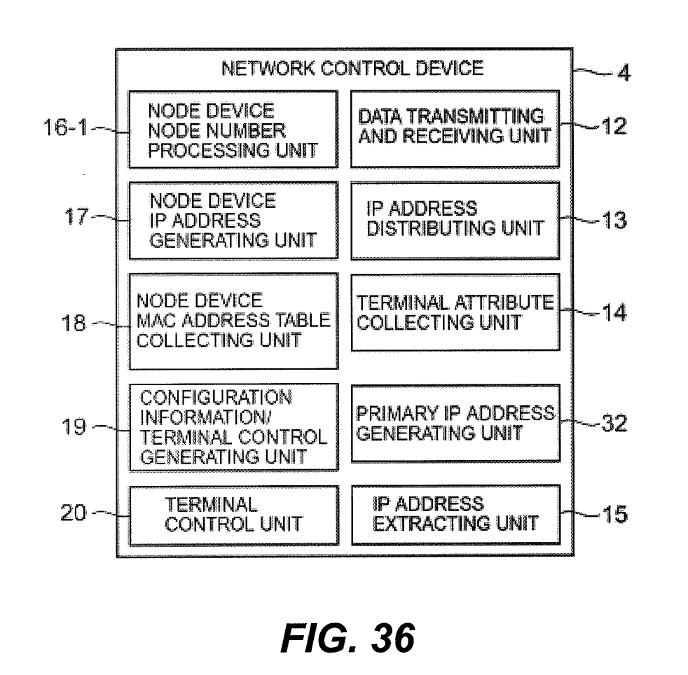

A fourth device construction according to the present disclosure can be achieved by changing the node device and the master node device in FIG. 1 to a node device and a master node device in FIG. 29 and by changing the network control device to a construction in FIG. 36.

That is, the fourth device construction of the IP address distributing device is a device characterized in that, for the second device construction, the network control device has means for allotting a primary IP address for the obtained MAC address of the terminal equipment and means for transmitting the primary IP address to the terminal equipment,

the terminal equipment has means for setting the IP address,

the network control device has means for requesting a terminal attribute to the terminal equipment using the primary IP address,

the terminal equipment has means for transmitting the terminal attribute by the terminal attribute request,

the network control device has means for generating a configuration information from the terminal attribute and the MAC address table, means for building up a terminal control, means for extracting the IP address to be set in the terminal equipment from the terminal control, and means for transmitting the extracted IP address to the corresponding terminal equipment using the primary IP address, and

the terminal equipment has means for setting the received IP address to the own terminal equipment.

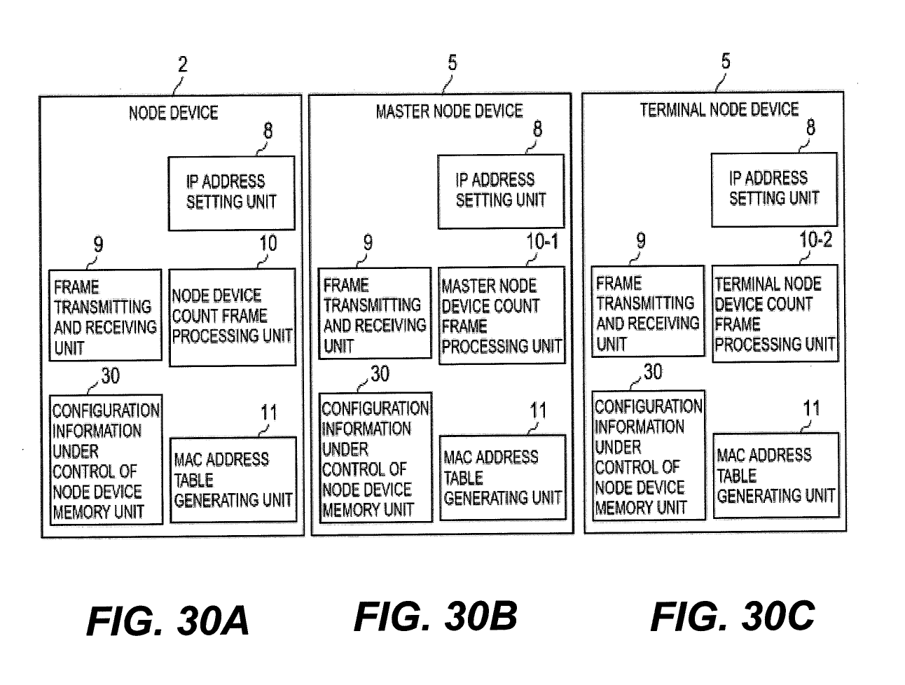

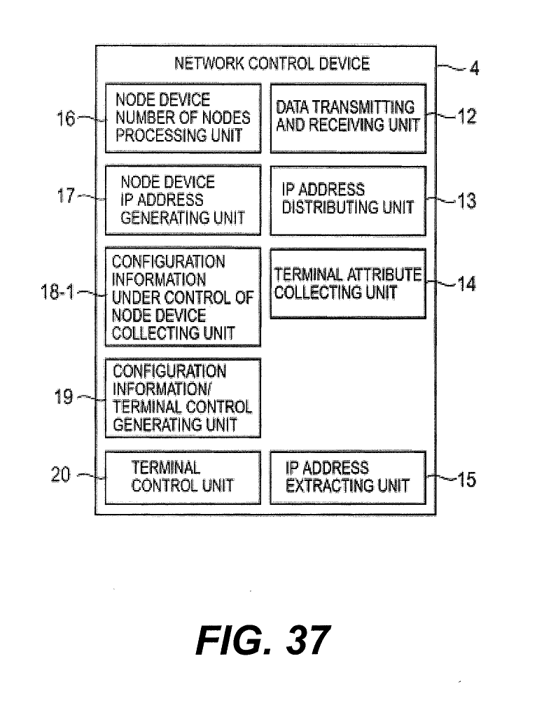

A fifth device construction according to the present disclosure can be achieved by changing the node device and the master node device in FIG. 1 to a node device and a master node device in FIG. 30 and by changing the network control device to a construction in FIG. 37.

That is, the fifth device construction of the IP address distributing device is a device characterized in that, in a loop type network composed of a network control device, a node device to perform route change by a MAC address and a terminal equipment to be connected to it,

the node device has means for transmitting and receiving a frame to be transmitted to the node device in order, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting the association frame and means for stopping the association frame,

the node device has means for generating a MAC address table which stores a transmission source MAC address of the inputted frame and an interface number inputted in the frame, and means for storing configuration information under the control of the node device in which the relation between the MAC address to be connected to the node device and the interface number of the node device to which the terminal equipment is connected and attribute information of the terminal equipment are described,

the network control device has means for obtaining the configuration information under the control of the node device, means for extracting the MAC address of the terminal equipment to be connected to the node device, the interface number of the node device and the attribute information of the terminal equipment from the obtained configuration information under the control of the node device, means for generating configuration information, means for building up terminal control, means for extracting an IP address to be set to the terminal equipment from the terminal control, and means for transmitting the extracted IP address to the corresponding terminal equipment, and

the terminal equipment has means for setting the received IP address to the own terminal equipment.

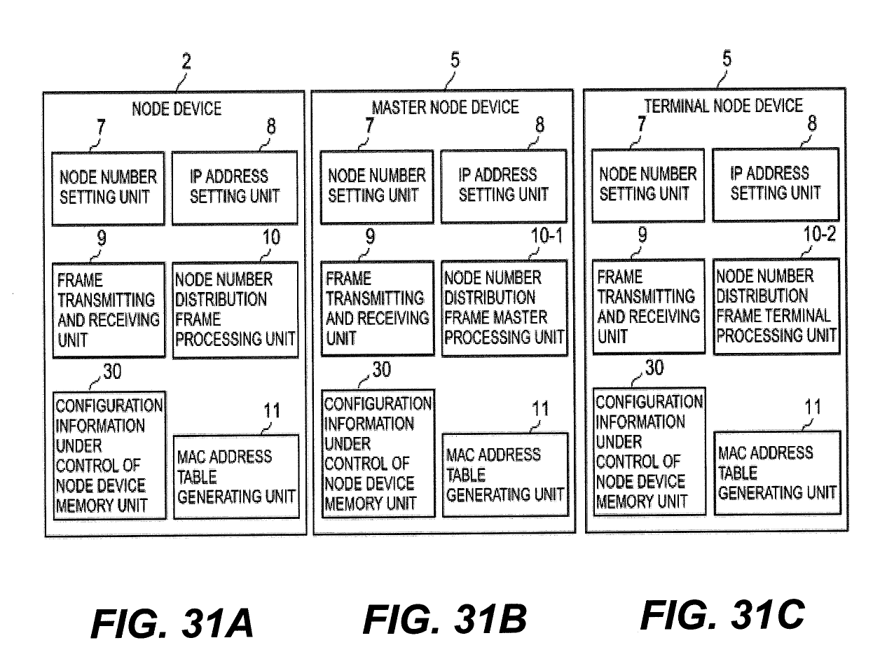

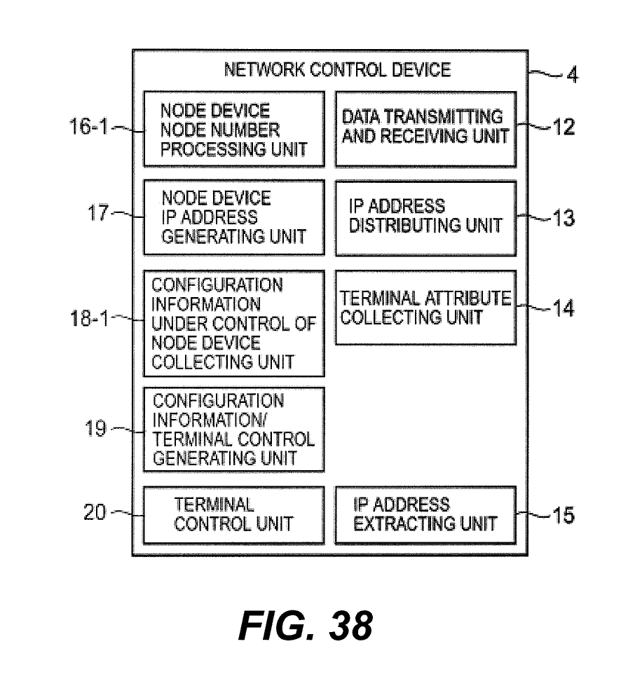

A sixth device construction according to the present disclosure can be achieved by changing the node device and the master node device in FIG. 1 to a node device and a master node device in FIG. 31 and by changing the network control device to a construction in FIG. 38.

That is, the sixth device construction of the IP address distributing device is a device characterized in that, a frame to be transmitted to the node device as stated in the fifth device construction describes a node number,

the node device which received the frame has means for setting the node number described in the frame to the own node device, for setting the number which is increased by a definite number from the node number of the received frame, and for sending it to the next adjacent node device, and means for obtaining the number of the node devices in the network from the node number of the frame which was transmitted to the first node device after transmitted to the node devices, and

the node device has means for describing the node number and the IP address in the frame to transmit, and the node device which received the frame in which the node number and the IP address are described has means for collating the node number described in the frame with the node number of the node device to set the IP address to the node device.

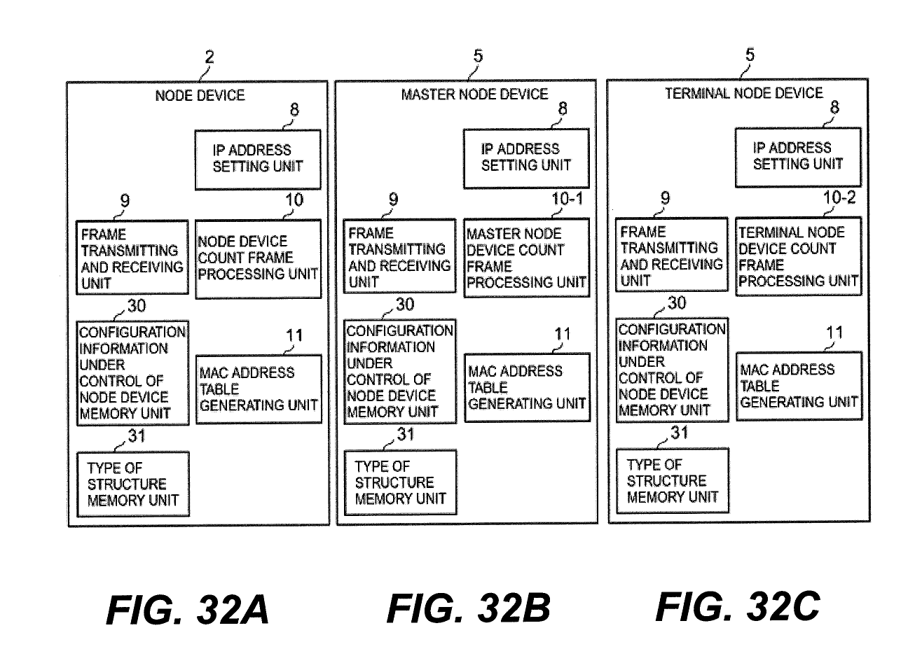

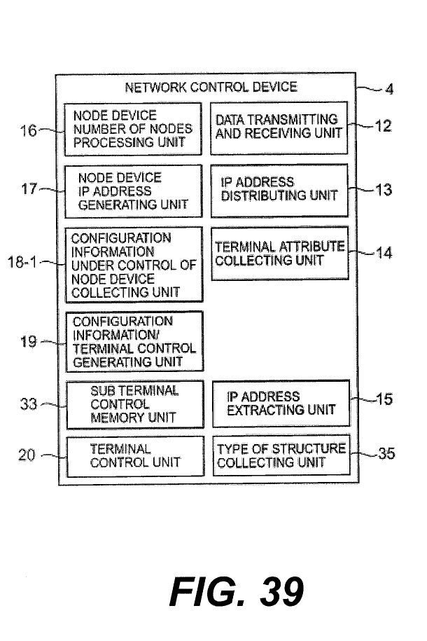

A seventh device construction according to the present disclosure can be achieved by changing the node device and the master node device in FIG. 1 to a node device and a master node device in FIG. 32 and by changing the network control device in FIG. 1 to a construction in FIG. 39.

That is, the seventh device construction of the IP address distributing device is a device characterized in that, in a loop type network composed of a network control device, a node device to perform route change by a MAC address and a terminal equipment to be connected to it,

the node device has means for transmitting and receiving a frame to be transmitted to the node device in order, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting the association frame and means for stopping the association frame,

the node device has means for generating a MAC address table which stores a transmission source MAC address of the inputted frame and an interface number in which the frame is inputted, and means for storing configuration information under the control of the node device in which the relation between the MAC address to be connected to the node device and the interface number of the node device to which the terminal equipment is connected and attribute information of the terminal equipment are described,

the network control device has means for obtaining the configuration information under the control of the node device and a type of structure, means for extracting the MAC address of the terminal equipment to be connected to the node device, the interface number of the node device and the attribute information of the terminal equipment from the obtained configuration information under the control of the node device, means for generating configuration information, means for storing a sub terminal control which constitutes a part of the construction of terminal control, means for building up the terminal control from the type of structure and the sub terminal control, means for extracting an IP address to be set to the terminal equipment from the terminal control, and means for transmitting the extracted IP address to the corresponding terminal equipment, and

the terminal equipment has means for setting the received IP address to the own terminal equipment.

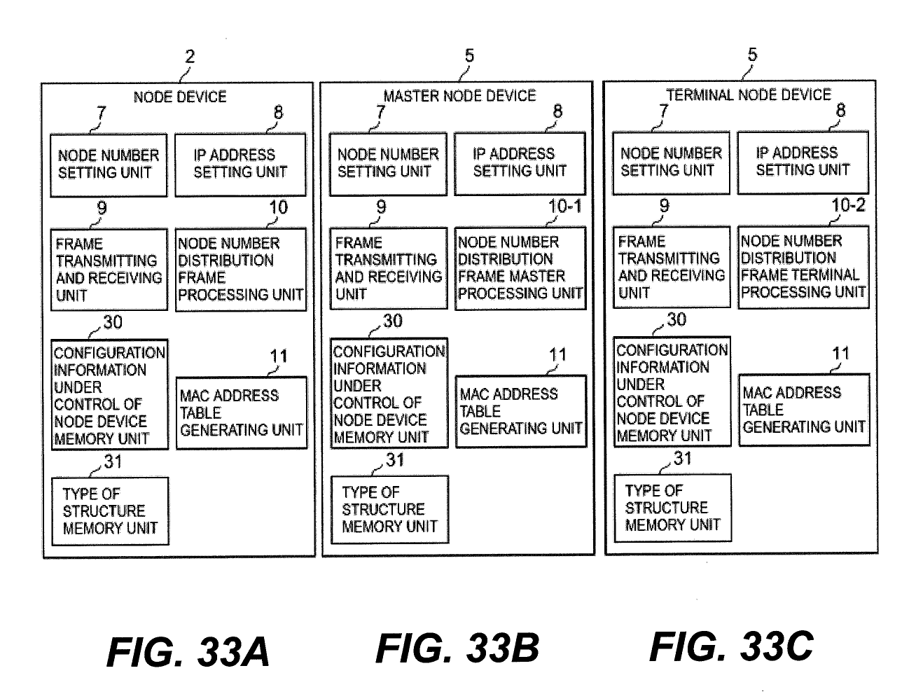

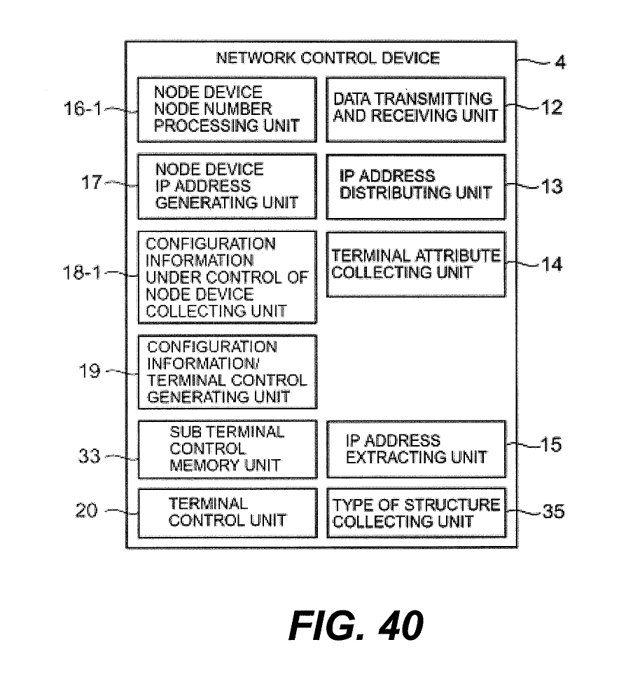

An eighth device construction according to the present disclosure can be achieved by changing the node device and the master node device in FIG. 1 to a node device and a master node device in FIG. 33 and by changing the network control device in FIG. 1 to a construction in FIG. 40.

That is, the eighth device construction of the IP address distributing device is a device characterized in that, a frame to be transmitted to the node device as stated in the seventh device construction describes a node number,

the node device which received the frame has means for setting the node number described in the frame to the own node device, for setting the number which is increased by a definite number from the node number of the received frame, and for sending it to the next adjacent node device, and means for obtaining the number of the node devices in the network from the node number of the frame which was transmitted to the first node device after transmitted to the node devices, and

the node device has means for describing the node number and the IP address in the frame to transmit, and the node device which received the frame in which the node number and the IP address are described has means for collating the node number described in the frame with the node number of the node device to set the IP address to the node device.

FIG. 26 shows a ninth device construction according to the present disclosure so as to embody an IP address distributing device for a bus type network.

That is, the ninth device construction of the IP address distributing device is a device characterized in that, in a bus type network composed of a network control device, a node device to perform route change by a MAC address, and a terminal equipment to be connected to it,

the node device has means for transmitting and receiving a frame to be transmitted to the node device in order, means for transferring the frame to a first one of the node devices, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting an association frame and means for stopping the association frame,

the node device has means for generating a MAC address table which stores a transmission source MAC address of the inputted frame and an interface number inputted in the frame,

the network control device has means to obtain the MAC address table, means for extracting the MAC address of the terminal equipment to be connected to the node device and a terminal interface number of the node device from the obtained MAC address table, and for requesting a terminal attribute for the terminal equipment using the MAC address of the terminal equipment,

the terminal equipment has means for transmitting the terminal attribute by the terminal attribute request, and

the network control device has means for generating a configuration information from the terminal attribute and the MAC address table, means for building up a terminal control, means for extracting an IP address to be set in the terminal equipment from the terminal control, and means for transmitting the extracted IP address to the corresponding terminal equipment, and

the terminal equipment has means for setting the received IP address to the own terminal equipment.

A tenth device construction according to the present disclosure can be achieved by changing the node device, the master node device, and the terminal node device in FIG. 26 to a node device, a master node device, and a terminal node device in FIG. 29 and by changing the network control device to a construction in FIG. 34.

That is, the tenth device construction of the IP address distributing device is a device characterized in that, a node number is described in the frame to be transmitted to the node device as recited in the ninth device construction,

the node device which received the frame has means for setting the node number described in the frame to the own node device, for setting the number which is increased by a definite number from the node number of the received frame, and for sending it to the next adjacent node device, means for transferring the frame to a first one of the node devices, and means for obtaining the number of the node devices in the network from the node number of the frame which was transmitted to the first node device after transmitted to the node devices, and

the node device has means for describing the node number and IP address in the frame to transmit, and the node device which received the frame in which the node number and the IP address are described has means for collating the node number described in the frame with the node number of the node device to set the IP address to the node device.

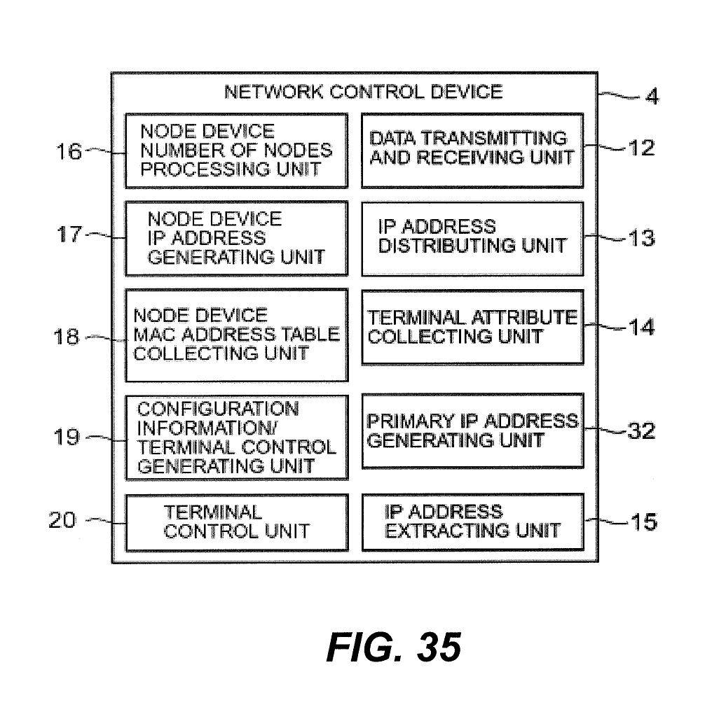

An eleventh device construction according to the present disclosure can be achieved by changing the node device, the master node device, and the terminal node device in FIG. 26 to a node device, a master node device, and a terminal node device in FIG. 31 and by changing the network control device to a construction in FIG. 35.

That is, the eleventh device construction of the IP address distributing device is a device characterized in that, the network control device as recited in the ninth device construction has means for allotting a primary IP address for the obtained MAC address of the terminal equipment and means for transmitting the primary IP address to the terminal equipment,

the terminal equipment has means for setting the IP address,

the network control device has means for requesting a terminal attribute to the terminal equipment using the primary IP address,

the terminal equipment has means for transmitting the terminal attribute by the terminal attribute request,

the network control device has means for generating a configuration information from the terminal attribute and the MAC address table, means for building up a terminal control, means for extracting the IP address to be set in the terminal equipment from the terminal control, and means for transmitting the extracted IP address to the corresponding terminal equipment using the primary IP address, and

the terminal equipment has means for setting the received IP address to the own terminal equipment.

A twelfth device construction according to the present disclosure can be achieved by changing the node device, the master node device, and the terminal node device in FIG. 26 to a node device, a master node device, and a terminal node device in FIG. 29 and by changing the network control device to a construction in FIG. 36.

That is, the twelfth device construction of the IP address distributing device is a device characterized in that, the network control device as recited in the tenth device construction has means for allotting a primary IP address for the obtained MAC address of the terminal equipment and means for the primary IP address to the terminal equipment,

the terminal equipment has means for setting the IP address,

the network control device has means for requesting a terminal attribute to the terminal equipment using the primary IP address,

the terminal equipment has means for transmitting the terminal attribute by the terminal attribute request,

the network control device has means for generating a configuration information from the terminal attribute and the MAC address table, means for building up a terminal control, means for extracting the IP address to be set in the terminal equipment from the terminal control, and means for transmitting the extracted IP address to the corresponding terminal equipment using the primary IP address, and

the terminal equipment has means for setting the received IP address to the own terminal equipment.

A thirteenth device construction according to the present disclosure can be achieved by changing the node device, the master node device, and the terminal node device in FIG. 26 to a node device, a master node device, and a terminal node device in FIG. 30 and by changing the network control device in FIG. 37.

That is, the thirteenth device construction of the IP address distributing device is a device characterized in that, in a bus type network composed of a network control device, a node device to perform route change by a MAC address and a terminal equipment to be connected to it,

the node device has means for transmitting and receiving a frame to be transmitted to the node device in order, means for transferring the frame to a first one of the node devices, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting the association frame and means for stopping the association frame,

the node device has means for generating a MAC address table which stores a transmission source MAC address of the inputted frame and an interface number inputted in the frame, and means for storing configuration information under the control of the node device in which the relation between the MAC address to be connected to the node device and the interface number of the node device to which the terminal equipment is connected and attribute information of the terminal equipment are described,

the network control device has means for obtaining the configuration information under the control of the node device, means for extracting the MAC address of the terminal equipment to be connected to the node device, the interface number of the node device and the attribute information of the terminal equipment from the obtained configuration information under the control of the node device, means for generating configuration information, means for building up terminal control, means for extracting an IP address to be set to the terminal equipment from the terminal control, and means for transmitting the extracted IP address to the corresponding terminal equipment, and

the terminal equipment has means for setting the received IP address to the own terminal equipment.

A fourteenth device construction according to the present disclosure can be achieved by changing the node device, the master node device, and the terminal node device in FIG. 26 to a node device, a master node device, and a terminal node device in FIG. 31 and by changing the network control device in FIG. 38.

That is, the fourteenth device construction of the IP address distributing device is a device characterized in that, a frame to be transmitted to the node device as stated in the thirteenth device construction describes a node number,

a frame to be transmitted to the node device as stated in the thirteenth device construction describes a node number,

the node device which received the frame has means for setting the node number described in the frame to the own node device, for setting the number which is increased by a definite number from the node number of the received frame, and for sending it to the next adjacent node device, means for transferring the frame to a first one of the node devices, and means for obtaining the number of the node devices in the network from the node number of the frame which was transmitted to the first node device after transmitted to the node devices, and

the node device has means for describing the node number and the IP address in the frame to transmit, and the node device which received the frame in which the node number and the IP address are described has means for collating the node number described in the frame with the node number of the node device to set the IP address to the node device.

A fifteenth device construction according to the present disclosure can be achieved by changing the node device, the master node device, and the terminal node device in FIG. 26 to a node device, a master node device, and a terminal node device in FIG. 32 and by changing the network control device to a construction in FIG. 39.

That is, the fifteenth device construction of the IP address distributing device is a device characterized in that, in a bus type network composed of a network control device, a node device to perform route change by a MAC address and a terminal equipment to be connected to it,

the node device has means for transmitting and receiving a frame to be transmitted to the node device in order, means for transferring the frame to a first one of the node devices, means for measuring the number of the node devices by the frame, and means for transmitting the number of the node devices to the network control device,

the network control device has means for generating an IP address and means for transmitting the IP address to one of the node devices,

the node device has means for distributing the IP address which is received from the network control device to the node device,

the terminal equipment has means for transmitting the association frame and means for stopping the association frame,

the node device has means for generating a MAC address table which stores a transmission source MAC address of the inputted frame and an interface number in which the frame is inputted, and means for storing configuration information under the control of the node device in which the relation between the MAC address to be connected to the node device and the interface number of the node device to which the terminal equipment is connected and attribute information of the terminal equipment are described,

the network control device has means for obtaining the configuration information under the control of the node device and a type of structure, means for extracting the MAC address of the terminal equipment to be connected to the node device, the interface number of the node device and the attribute information of the terminal equipment from the obtained configuration information under the control of the node device, means for generating configuration information, means for storing a sub terminal control which constitutes a part of the construction of terminal control, means for building up the terminal control from the type of structure and the sub terminal control, means for extracting an IP address to be set to the terminal equipment from the terminal control, and means for transmitting the extracted IP address to the corresponding terminal equipment, and

the terminal equipment has means for setting the received IP address to the own terminal equipment.

A sixteenth device construction according to the present disclosure can be achieved by changing the node device, the master node device, and the terminal node device in FIG. 26 to a node device, a master node device, and a terminal node device in FIG. 33 and by changing the network control device to a construction in FIG. 40.

That is, the sixteenth device construction of the IP address distributing device is a device characterized in that, a frame to be transmitted to the node device as stated in the fifteenth device construction describes a node number,

the node device which received the frame has means for setting the node number described in the frame to the own node device, for setting the number which is increased by a definite number from the node number of the received frame, and for sending it to the next adjacent node device, means for transferring the frame to a first one of the node devices, and means for obtaining the number of the node devices in the network from the node number of the frame which was transmitted to the first node device after transmitted to the node devices, and

the node device has means for describing the node number and the IP address in the frame to transmit, and the node device which received the frame in which the node number and the IP address are described has means for collating the node number described in the frame with the node number of the node device to set the IP address to the node device.

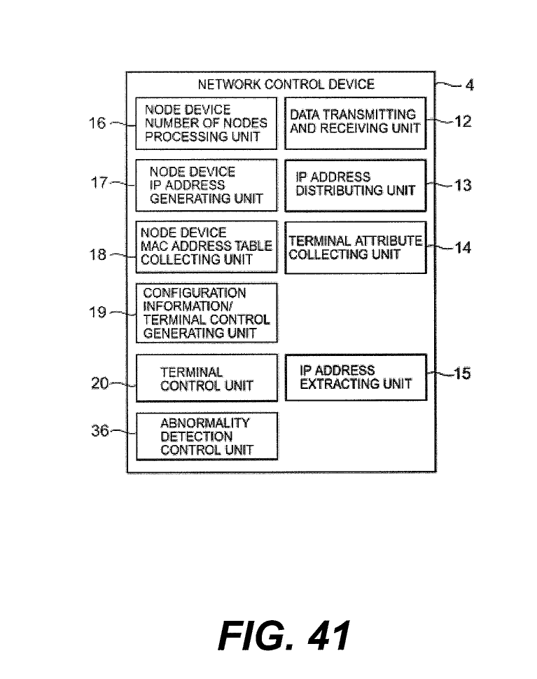

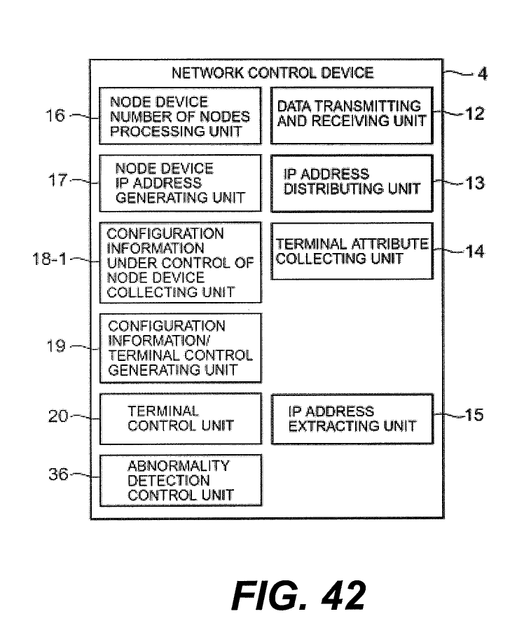

A seventeenth device construction according to the present disclosure can be achieved by providing an abnormality detection control unit in the network control device as shown in FIG. 41. In addition, FIG. 42 is a modification of a network control device in the case that the node device has a configuration information under the control of the node device memory unit.

That is, the seventeenth device construction of the IP address distributing device is a device characterized in that, the network control device has means for generating an abnormality detection control from the terminal control, means for transmitting a living confirmation request to the terminal equipment, means for discriminating existence or non-existence of abnormality of the terminal equipment from a living confirmation request response, and means for notifying a position information of the terminal equipment in the case that the terminal equipment is abnormal.

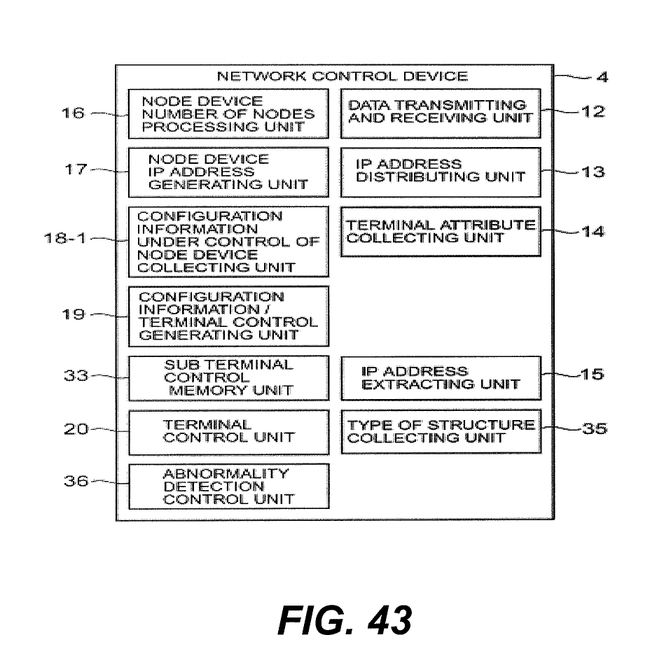

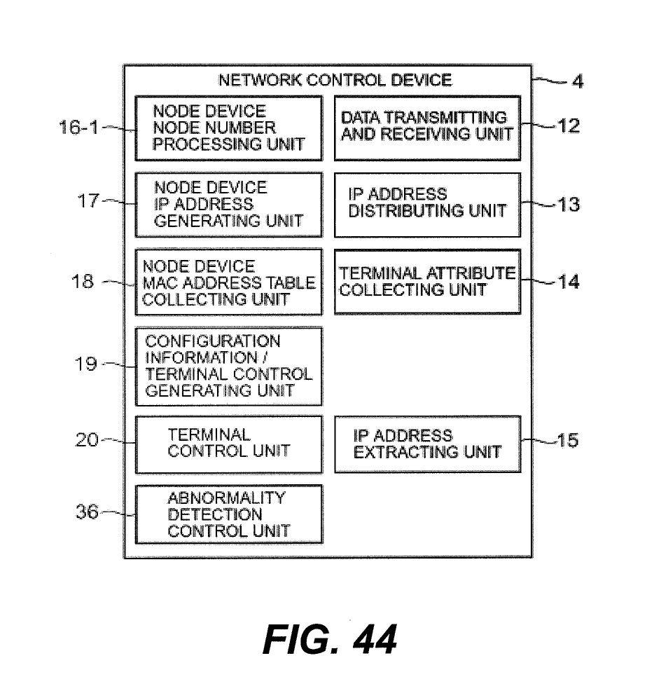

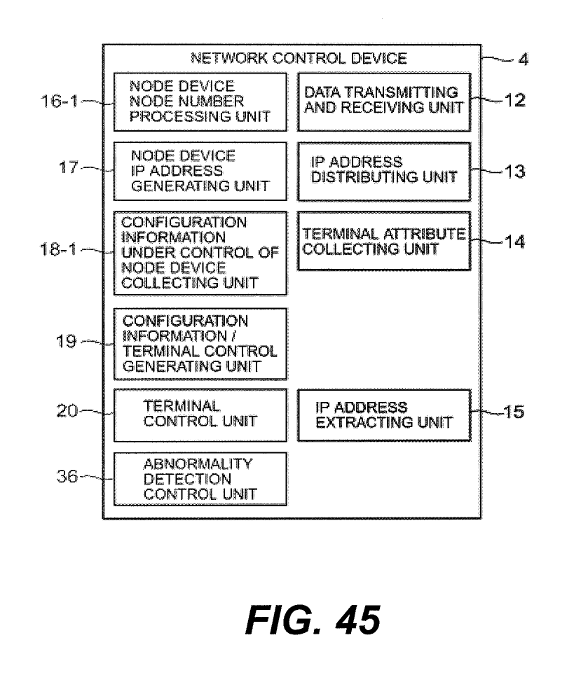

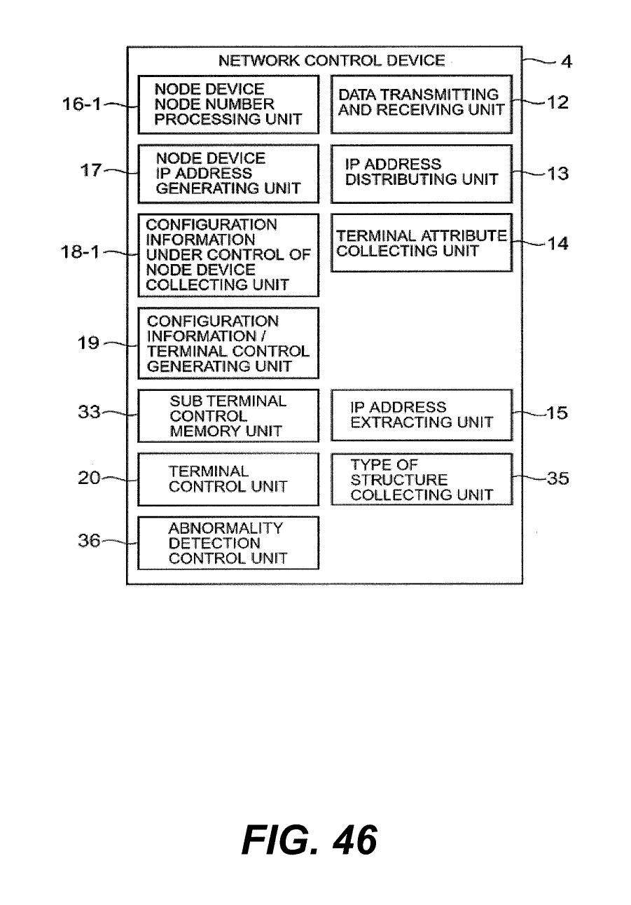

In addition, FIG. 43 shows a modification of a network control device in the case that the node device has a configuration information under the control of the node and a type of structure memory unit. FIG. 44 shows a modification of a network control device in the case that the node device sets a node number. FIG. 45 shows a modification of a network control device in the case that the node device sets a node number and has a configuration information under the control of the node device memory unit. FIG. 46 shows a modification of a network control device in the case that the node device sets a node number and has a configuration information under the control of the node and a type of structure memory unit.

As is composed of the method like this, it is possible to comprehend the necessary object to be controlled and allot the IP address automatically at the management device side, so that control can be made possible by building up the relation of the object to be controlled at the management device side concurrently.

In addition, as the node device is installed for each vehicle, the position of the terminal can be found, so that the identification of the object can be made easy in the case that the device becomes abnormal.

What is claimed is:

1. A method comprising:
arranging a plurality of node devices in sequence;
generating a device count frame with a device count number in a first node device;
transmitting the device count frame to each node device in sequence, each node device increasing the device count number of the device count frame upon receipt of the device count frame;
returning the device count frame to the first node device after each node device has increased the device count number of the device count frame; and
assigning an IP address for each node device, the number of IP addresses determined by the device count number.

2. The method of claim 1 further comprising:
associating a plurality of terminal devices to each node device; and
transmitting terminal device hardware information from each terminal device to the respective associated node device.

3. The method of claim 2 wherein the hardware information comprises a MAC address, an interface number, and hardware attribute information.

4. The method of claim 3 further comprising:
each terminal device transmitting a data frame containing its MAC address and interface number to its respective node device;
each node device generating an address table containing its respective terminal device MAC addresses and interface numbers; and
a control device obtaining the address table from each of the node devices and requesting a terminal attribute for each terminal device using the MAC address of each terminal device.

5. The method of claim 4 further comprising:
each terminal device transmitting the terminal attribute in accordance with the terminal attribute request;
the control device receiving each terminal attribute, generating an IP address for each terminal device, transmitting the IP address to each terminal device; and
each terminal device setting its IP address to the received IP address transmitted to it.

6. The method of claim 5 wherein transmitting the IP address to each terminal device comprises transmitting a sequential list of IP addresses, and wherein each terminal device setting its IP address comprises setting the terminal device's IP address to the first IP address in the list, removing the first IP address on the list, and transmitting the list to another terminal device.

7. The method of claim 5 further comprising generating configuration information indicating a construction of the system using the terminal attribute and the MAC address tables in the control device.

8. The method of claim 1 wherein the node devices are arranged in a loop.

9. The method of claim 1 wherein the node devices are arranged on a bus.

10. A system comprising:
a plurality of node devices arranged in sequence;
a first node device operable to generate a device count frame with a device count number and transmit the device count frame to the next node device in the sequence;
a control device in communication with at least the first node device;
wherein each node device is operable to increase the device count number of the device count frame upon receipt of the device count frame and transmit the device count frame to the next node device in sequence; and
wherein the control device operable to receive the device count frame to the first node device after each node device has increased the device count number of the device count frame and assign an IP address for each node device, the number of IP addresses determined by the device count number.

11. The system of claim 10 further comprising:
a plurality of terminal devices associated with each node device, each terminal device operable to transmit terminal device hardware information to the respective associated node device.

12. The system of claim 11 wherein the hardware information comprises a MAC address, an interface number, and hardware attribute information.

13. The system of claim 10 wherein each terminal device is further operable to transmit a data frame containing its MAC address and interface number to its respective node device, each node device is further operable to generate an address table containing its respective terminal device MAC addresses and interface numbers; and the control device is operable to obtain the address table from each of the node devices and request a terminal attribute for each terminal device using the MAC address of each terminal device.

14. The system of claim 13 wherein each terminal device is further operable to transmit the terminal attribute in accordance with the terminal attribute request, the control device is further operable to receive each terminal attribute, generate an IP address for each terminal device, and transmit the IP address to each terminal device, each terminal device further operable to set its IP address to the IP address transmitted to it by the control device.

15. The system of claim 10 further comprising a plurality of rail vehicles, each node device associated with a single rail vehicle.

16. A system comprising:
a control device in communication with a plurality of node devices, each node device associated with a rail vehicle, each rail vehicle arranged in sequence, wherein the control device is operable to:
receive a device count frame with a device count number, the device count number equaling the number of node devices; and
assign an IP address to each node device based on the number of node devices indicated in the device count frame.

17. The system of claim 16 wherein the control device is further operable to:
receive address tables generated by each of the node devices, the address table generated by each node device and comprising a MAC address and interface number from a plurality of terminal devices,
request a terminal attribute from each terminal device using the MAC address of each terminal device from the address table;
receive each terminal attribute from each terminal device;
generate an IP address for each terminal device; and
transmit the IP address to each terminal device, each terminal device setting its IP address to the IP address transmitted to it by the control device.

18. The system of claim 17 wherein the control device is further operable to transmit the IP address to each terminal device by transmitting a sequential list of IP addresses, each terminal device setting its IP address to the first IP address in the list, removing the first IP address on the list, and transmitting the list to another terminal device.

19. The system of claim 17 wherein the control device is further operable to generate configuration information indicating a construction of the system using the terminal attribute and the address tables.

20. The system of claim 17 wherein the control device is further operable to transmit a status request to at least one terminal device, receive a status response from the terminal device in response to the status request, and report the status response of the terminal device.
